(19) United States
(12) Patent Application Publication
(10) Pub. No.: US 2026/0307512 A1
(43) Pub. Date: Oct. 8, 2026

(54) MULTISOURCE HYBRID ENERGY STORAGE SYSTEM FOR ELECTRIC VEHICLES

(71) Applicant: KING FAHD UNIVERSITY OF PETROLEUM AND MINERALS, Dhahran (SA)

(72) Inventors: Muhammad KHALID, Dhahran (SA); Kamran ZEB, Dhahran (SA)

(73) Assignee: KING FAHD UNIVERSITY OF PETROLEUM AND MINERALS, Dhahran (SA)

(21) Appl. No.: 19/098,416

(22) Filed: Apr. 2, 2025

(51) Int. Cl. B60L 50/75; B60L 8/00; B60L 50/40; H02M 3/158

(52) U.S. Cl. CPC B60L 50/75; B60L 8/003; B60L 50/40; H02M 3/1582; B60L 2210/14; B60L 2210/42

(57) ABSTRACT

A hybrid energy storage system used in an electric vehicle comprises multiple energy sources, including a fuel cell, a battery, a supercapacitor, and a photovoltaic panel. The system further comprises multiple DC-DC converters, a DC bus, a DC-AC inverter, and a sliding mode controller. Inputs of a first, a second, a third, and a fourth DC-DC converters are coupled to the fuel cell, the battery, the supercapacitor and the photovoltaic panel, respectively. Outputs of the first, second, third, and fourth DC-DC converters are coupled to the DC bus. The DC-AC inverter supplies AC electric power to a motor of an electric vehicle. The sliding mode controller controls operation of the hybrid energy storage system by applying a barrier-function-based controller gain to regulate a DC voltage at the DC bus to a reference voltage.

### STATEMENT REGARDING PRIOR DISCLOSURE BY THE INVENTORS

Aspects of this technology are described in an article by Faiqa Noor, Kamran Zeb, Saif Ullah, Zahid Ullah, Muhammad Khalid, and Ahmed Al-Durra, titled “Design and Validation of Adaptive Barrier Function Sliding Mode Controller for a Novel Multisource Hybrid Energy Storage System Based Electric Vehicle” published in IEEE Access, Volume 12. The publication is herein incorporated by reference in its entirety.

### STATEMENT OF ACKNOWLEDGEMENT

Support provided by King Fahd University of Petroleum and Minerals (KFUPM), King Abdullah City for Atomic and Renewable Energy, and the Politecnico di Milano, Italy is gratefully acknowledged.

### BACKGROUND

### Technical Field

The present disclosure is directed to electric vehicles (EVs) and, more particularly, to systems and methods for multisource hybrid energy storage for the EVs.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The standard of living is improving daily, and conventional energy sources are consuming large amounts of energy. Automobiles powered by internal combustion engines (ICEs) and fossil fuels are in high demand. The extensive consumption of fossil fuels, oil, and natural gas is leading to their rapid depletion. Conventional vehicles emit numerous pollutants and greenhouse gases, such as carbon dioxide and nitrogen oxides, which deteriorate air quality. These vehicles contribute to global warming, climate change, and higher fuel consumption costs.

In response, Hybrid Electric Vehicles (HEVs) have been developed to address the dual issues of harmful emissions and resource depletion. Electric Vehicles (EVs) serve as an alternative to traditional vehicles by saving energy and reducing fuel usage. Additionally, EVs are environmentally friendly, emission-free, and produce less noise. However, the challenges associated with EVs include reducing costs and improving their longevity and performance. To enhance performance and increase usage time, EVs require energy storage devices (ESDs) with high power density. ESDs with high power density allow for rapid charging and discharging.

While Supercapacitors (SC) offer high power density and long life, their energy cost is high, and they have low energy density. On the other hand, batteries have high energy density but shorter lifespans and lower power density. This issue is addressed by hybridizing various ESDs with high energy and low power density. Manufacturers are now producing EVs with diverse energy sources and ESDs. EVs are categorized based on their energy sources:
Battery Electric Vehicles (BEVs) are charged by an external source but have a limited lifetime.
Hybrid Electric Vehicles (HEVs) use both an electric motor and ICE but are not entirely emission-free.
Plug-in Hybrid Electric Vehicles (PHEVs) combine an ICE with a battery.
Fuel Cell Hybrid Electric Vehicles (FCHEVs) use a fuel cell (FC) as an energy source and overcome many of the issues of traditional vehicles, though they are expensive.

Since neither FCs nor batteries alone meet all the requirements for EVs, hybridized ESDs are necessary. A key challenge for hybrid systems is designing an optimal Hybrid Energy Storage System (HESS) that manages power distribution between ESDs for enhanced performance.

Several energy management strategies are employed in HESS for HEVs. For instance, an energy storage system for multi-source HEVs based on super-twisting Sliding Mode Control (SMC) offers a stable, fast multi-objective optimization method for energy management. A Perturb and Observe (P&O) energy management control technique, combined with Tuna Swarm Optimization (TSO), helps prevent rapid battery discharge and extends battery life in HESS. Using two or more ESDs in HESS improves EV performance, fuel economy, and lifespan of energy sources within their Energy Management Systems (EMS).

Model Predictive Control (MPC)-based adaptive EMS for PHEVs, using a deep neural network for velocity prediction, enhances performance by incorporating a driver behavior model. Furthermore, Rule-interposing Deep Reinforcement Learning (DRL)-based EMS stabilizes HEV systems and improves fuel economy, though it demands considerable memory for optimal performance.

For PHEVs, a multi-neural network-based predictive EMS improves fuel economy, but battery degradation has yet to be fully accounted for. Reinforcement learning-based Stochastic MPC for PHEVs also boosts fuel economy, though performance improvements are still required. A real-time bi-adaptive controller-based EMS for HEVs reduces power losses, temperature, and battery stress, though it has not been implemented in hardware.

Dynamic programming and receding horizon-based optimal EMS for HEVs tend to be memory-intensive, calling recursive functions. A machine learning-based sustainable power management system for light EVs uses HESS to optimize performance. Fuzzy logic-based EMS for HESS in EVs relies on human knowledge and requires regular updates to its rules.

Hybrid techniques, such as combining Sand Cat Swarm Optimization (SCSO) with Recalling Enhanced Recurrent Neural Networks (RERNN) and integrating Namib Beetle Optimization (NBO) with Quantum Neural Networks (QNN), are also explored for managing HESS in EVs. Pulse width modulation (PWM) is an efficient method for HESS design, but it is complex and expensive.

Machine learning-based HESS for EVs aims to reduce operating costs, though the performance of the EMS still requires validation. A barrier function-based non-singular terminal SMC has been designed for path-tracking agricultural vehicles to handle unknown disturbances, improving convergence speed. In multi-agent systems with unknown disturbances, a barrier function-based adaptive SMC is employed, although it only considers first-order dynamics. Further research is needed on agents with higher-order dynamics.

For uncertain nonlinear systems, input saturation-based barrier function adaptive SMC is being developed. Nonlinear barrier-conditioned SMC has been applied in the control of PHEVs, while HESS for EVs operating on both batteries and SCs has been developed. However, vehicle specifications are often not considered when designing HESS. SMC-based HESS for HEVs exhibits high peak values and steady-state error in DC bus voltage when the load changes, and the presence of integral terms slows the system response. These hybrid systems show nonlinear behavior due to fluctuating resistances, inductances, and switches, creating a need for a nonlinear controller for such systems.

Accordingly, it is one object of the present disclosure to provide a system and method for overcoming the limitations of conventional HESS for EVs by offering a barrier function-based adaptive sliding mode controller (BFASMC) for a hybrid energy storage system (HESS) of electric Vehicle (EV). The HESS comprises a fuel cell (FC), a battery, a supercapacitor (SC), and a photovoltaic (PV) panel. The FC serves as a primary source, while the others are auxiliary sources. DC converters are employed to couple these sources to a DC bus. The proposed BFASMC stabilizes and regulates the DC bus voltage. The system's global stability has been assured through Lyapunov criteria and verified through a phase plane (e.g., error and error differential) analysis.

### SUMMARY

In an exemplary embodiment, a multisource hybrid energy storage system used in an electric vehicle is described. The multisource hybrid energy storage system comprises a plurality of energy sources, a plurality of DC-DC converters, a DC bus, a DC-AC inverter, and a sliding mode controller. The plurality of energy sources include a fuel cell, a battery, a supercapacitor, and a photovoltaic panel. The plurality of DC-DC converters include a first DC-DC converter, a second DC-DC converter, a third DC-DC converter, and a fourth DC-DC converter. An input of the first DC-DC converter is coupled to the fuel cell, and an output of the first DC-DC converter is coupled to the DC bus. An input of the second DC-DC converter is coupled to the battery, and an output of the second DC-DC converter is coupled to the DC bus. An input of the third DC-DC converter is coupled to the supercapacitor, and an output of the third DC-DC converter is coupled to the DC bus. An input of the fourth DC-DC converter is coupled to the photovoltaic panel, and an output of the fourth DC-DC converter is coupled to the DC bus. The DC-AC inverter inverts DC electric power from the DC bus into AC electric power and supplies the AC electric power to a motor of the electric vehicle. The sliding mode controller controls operation of the multisource hybrid energy storage system by applying a barrier-function-based controller gain to regulate a DC voltage at the DC bus to a reference voltage.

In another exemplary embodiment, an electric vehicle comprises a motor and a multisource hybrid energy storage system for powering the motor is described. The multisource hybrid energy storage system includes a plurality of energy sources, a plurality of DC-DC converters, a DC bus, a DC-AC inverter, and a sliding mode controller. The plurality of energy sources include a fuel cell, a battery, a supercapacitor, and a photovoltaic panel. The plurality of DC-DC converters include a first DC-DC converter, a second DC-DC converter, a third DC-DC converter, and a fourth DC-DC converter. An input of the first DC-DC converter is coupled to the fuel cell, and an output of the first DC-DC converter is coupled to the DC bus. An input of the second DC-DC converter is coupled to the battery, and an output of the second DC-DC converter is coupled to the DC bus. An input of the third DC-DC converter is coupled to the supercapacitor, and an output of the third DC-DC converter is coupled to the DC bus. An input of the fourth DC-DC converter is coupled to the photovoltaic panel, and an output of the fourth DC-DC converter is coupled to the DC bus. The DC-AC inverter inverts DC electric power from the DC bus into AC electric power and supplies the AC electric power to the motor. The controller is a sliding mode controller configured to apply a barrier-function-based controller gain to regulate a DC voltage at the DC bus to a reference voltage.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates an exemplary block diagram of a hybrid energy storage system (HESS), according to certain embodiments.

FIG. 2 illustrates an exemplary block diagram of an electric vehicle comprising the HESS, according to certain embodiments.

FIG. 3 illustrates an exemplary circuit diagram of the HESS, according to certain embodiments.

FIG. 4 illustrates an exemplary graphical representation of phase plane of a sliding mode controller (SMC), according to certain embodiments.

FIGS. 5A-5B illustrate exemplary graphical representations of A_{pb (x)} and A_{psb (x)}, respectively, according to certain embodiments.

FIG. 6 illustrates an exemplary graphical representation of load profile (iₒ), according to certain embodiments.

FIGS. 7A-7D illustrate exemplary graphical representations of direct current (DC) bus voltage, according to certain embodiments.

FIGS. 8A-8B illustrate exemplary graphical representations of fuel cell current, according to certain embodiments.

FIGS. 9A-9B illustrate exemplary graphical representations of battery current, according to certain embodiments.

FIGS. 10A-10B illustrate exemplary graphical representations of supercapacitor current, according to certain embodiments.

FIGS. 11A-11B illustrate exemplary graphical representations of photovoltaic (PV) panel currents, according to certain embodiments.

FIGS. 12A-12B illustrate an exemplary graphical representation of DC bus voltage error, according to certain embodiments.

FIG. 13 illustrates an exemplary graphical representation of fuel cell current error, according to certain embodiments.

FIG. 14 illustrates an exemplary graphical representation of battery current error, according to certain embodiments.

FIG. 15 illustrates an exemplary graphical representation of supercapacitor current error, according to certain embodiments.

FIG. 16 illustrates an exemplary graphical representation of PV panel current error, according to certain embodiments.

FIG. 17 illustrates an exemplary graphical representation of solar irradiance variation on a PV panel, according to certain embodiments.

FIG. 18 illustrates an exemplary graphical representation of pulse width modulation (PWM) duty ratio of control input (b₁), according to certain embodiments.

FIG. 19 illustrates an exemplary graphical representation of PWM duty ratio of control input (b₂₃), according to certain embodiments.

FIG. 20 illustrates an exemplary graphical representation of PWM duty ratio of control input (b₄₅), according to certain embodiments.

FIG. 21 illustrates an exemplary graphical representation of PWM duty ratio of control input (b₆), according to certain embodiments.

FIGS. 22A-22C illustrate exemplary graphical representations of comparison of phase plane of controllers the SMC, an integral SMC (ISMC), a double integral (DISMC), and a barrier function-based adaptive sliding mode controller (BFASMC), according to certain embodiments.

FIG. 23 illustrates an exemplary experimental setup, according to certain embodiments.

FIG. 24 illustrates an exemplary graphical representation of DC bus voltage (dSPACE), according to certain embodiments.

FIG. 25 illustrates an exemplary graphical representation of fuel cell current (dSPACE), according to certain embodiments.

FIG. 26 illustrates an exemplary graphical representation of battery current (dSPACE), according to certain embodiments.

FIG. 27 illustrates an exemplary graphical representation of supercapacitor current (dSPACE), according to certain embodiments.

FIG. 28 illustrates an exemplary graphical representation of PV current (dSPACE), according to certain embodiments.

FIG. 29 illustrates a non-limiting example of details of computing hardware used in the computing system, according to certain embodiments.

FIG. 30 illustrates an exemplary schematic diagram of a data processing system used within the computing system, according to certain embodiments.

FIG. 31 illustrates an exemplary schematic diagram of a processor used with the computing system, according to certain embodiments.

FIG. 32 illustrates an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system and a method of hybrid energy storage system (HESS) for electric vehicles (EVs) employing a barrier function-based adaptive sliding mode controller (BFASMC). Conventional controllers (e.g., the integral sliding mode controller (ISMC) and the double integral sliding mode controller (DISMC)) reduce convergence time, chattering effect and steady-state error that appears in the SMC but requires additional integral terms, making the system response slower. Due to this, these controllers (e.g., ISMC and DISMC) require a longer time to stabilize the controller gain. By adding integral terms, the system becomes unstable and has a slow oscillatory response due to which fast disturbances in load cause oscillations.

The present disclosure relates to a system and a method that employs the barrier function-based adaptive sliding mode controller (BFASMC) to improve DC bus voltage results during load disturbance by reducing the convergence time and chattering effect without involving any integral term. The proposed controller (i.e., BFASMC) reduces the steady-state error. Due to the robust nature of the BFASMC, it can quickly adapt to any changes in the system or environment. The BFASMC may deal with system disturbances and uncertainties without overestimating the controller gain, which makes the BFASMC more effective while keeping the system stable within the desired output. Furthermore, the BFASMC has finite-time convergence of output variables to a predefined neighborhood of zero independent of bound disturbance. The BFASMC hypothetically does not need a low pass filter or bound disturbance. The BFASMC is based on a barrier function having adaptive gains. The gain obtained by the BF is not overestimated because the BF converges the output variable to a predefined neighborhood of zero.

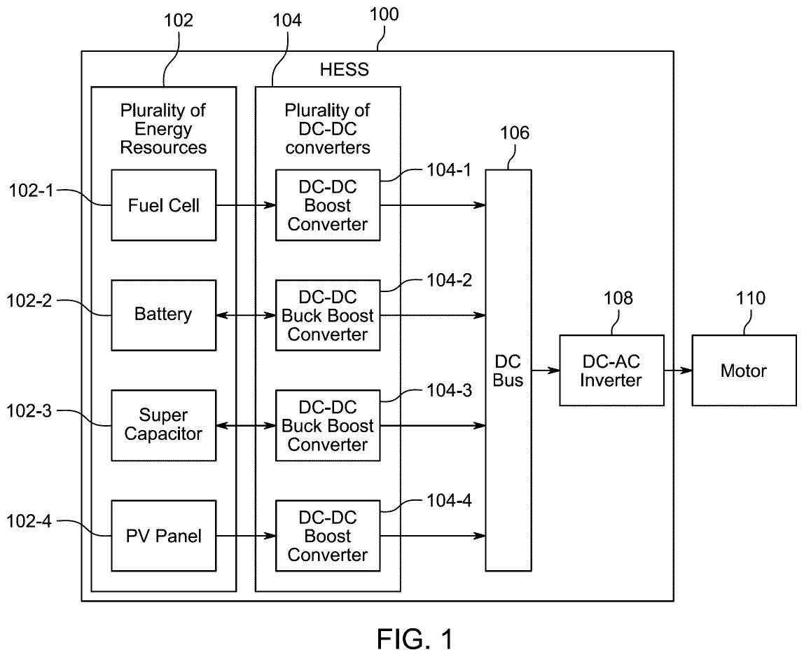

FIG. 1 illustrates an exemplary block diagram of a hybrid energy storage system (HESS) 100, according to certain embodiments.

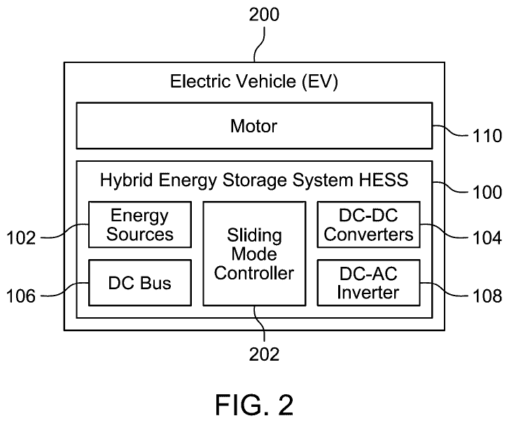

As used herein, the term HESS refers to an energy storage system that combines two or more different types of energy storage technologies to improve the overall efficiency, reliability, and performance of the system. The HESS 100 employs a barrier function-based adaptive sliding mode controller (BFASMC) for Electric Vehicles (EVs). The multisource hybrid energy storage system (HESS) 100 comprises a plurality of energy sources 102, a plurality of DC-DC converters 104, a DC bus 106, a DC-AC inverter 108, and a sliding mode controller (202 as shown in FIG. 2). The plurality of energy resources 102 includes a fuel cell (FC) 102-1, a battery 102-2, a super capacitor (SC) 102-3, and a photovoltaic (PV) panel 102-4 as energy sources, as shown in FIG. 1.

In an aspect, the fuel cell (FC) 102-1 is a clean source of energy. The FC requires oxygen, hydrogen, and electrolytes for the generation of energy. The electrolyte facilitates the reaction between hydrogen and oxygen to generate the energy. In an aspect, the battery 102-2 is the rechargeable source that supplies power during a constant load. It has a high-power density and works for a longer time. The SC 102-3 has high capacitance. The SC 102-3 has self-charging and discharging capability and high-power density. The SC 102-3 is used at high load conditions. The PV panel 102-4 includes a plurality of photovoltaic panels arranged in strings. For example, each string has 15 PV panels, and one panel produces 65 W. The PV panel 102-4 are adjusted in such a way that they combine to generate power 1.35 kW (i.e., 15×65×c≅1350 W), where c is a positive constant and is equal to 1.385. The temperature and radiation of sunlight affect the power generated by PV panels. The PV panel is free of cost and an eco-friendly source of energy.

The plurality of DC-DC converters 104 include a first DC-DC boost converter 104-1, a second DC-DC buck-boost converter 104-2, a third DC-DC buck-boost converter 104-3, and a fourth DC-DC boost converter 104-4.

The first DC-DC boost converter 104-1 is a DC-DC boost converter. In an aspect, the DC-DC boost converter refers to an electronic circuit that steps up (increases) the voltage from a lower DC voltage to a higher DC voltage while maintaining the power (minus losses due to inefficiency) of the input.

An input of the first DC-DC boost converter 104-1 is coupled to the FC 102-1, and an output of the first DC-DC boost converter 104-1 is coupled to the DC bus 106. The first DC-DC boost converter 104-1 steps up FC voltage.

The second DC-DC buck-boost converter 104-2 is a DC-DC buck-boost converter. In an aspect, the DC-DC buck-boost converter refers to an electronic circuit used to convert a DC (direct current) input voltage to a different DC output voltage, where the output can either be higher or lower than the input voltage. This converter combines the functions of two types of converters (i.e., a buck converter and a boost converter). The buck converter steps down the voltage (reduces the input voltage to a lower output voltage) and the boost converter steps up the voltage (increases the input voltage to a higher output voltage). The buck-boost converter is versatile as it handles both voltage step-up and step-down operations.

An input of the second DC-DC buck-boost converter 104-2 is coupled to the battery 102-2, and an output of the second DC-DC converter is coupled to the DC bus 106. The second DC-DC buck-boost converter 104-2 steps up or steps down the battery voltage to regulate the DC bus voltage level.

The third DC-DC buck-boost converter 104-3 is a DC-DC buck-boost converter. An input of the third DC-DC buck-boost converter 104-3 is coupled to the SC 102-3, and an output of the third DC-DC converter is coupled to the DC bus 106. The third DC-DC buck-boost converter 104-3 allows the SC 102-3 to charge and discharge and helps in voltage regulations.

The fourth DC-DC boost converter 104-4 is a DC-DC boost converter. An input of the fourth DC-DC boost converter 104-4 is coupled to the photovoltaic (PV) panel 102-4, and an output of the fourth DC-DC boost converter 104-4 is coupled to the DC bus 106. The fourth DC-DC boost converter 104-4 steps up the PV voltage to the DC bus voltage level.

The plurality of energy sources 102 supply DC voltage to the DC bus 106 with the help of the plurality of DC-DC converters 104 to regulate speed and torque of a motor 110 of the electric vehicle (EV) (200 as shown in FIG. 2). To regulate the speed and torque of the motor, the DC-AC inverter 108 inverts DC electric power from the DC bus 106 into AC electric power and supplies the AC electric power to the motor 110 of the electric vehicle (EV). In an aspect, the plurality of DC-DC converters 104 are applied to the plurality of energy sources 102 to step up and step down their voltage level so that it can be adjusted to the desired voltage required at the DC bus 106.

FIG. 2 illustrates an exemplary block diagram of an electric vehicle 200 comprising the HESS 100, according to certain embodiments.

The electric vehicle (EV) 200 comprises the HESS 100 and the motor 110. The HESS 100 comprises the plurality of energy resources 102, the plurality of DC-DC converters 104, the DC bus 106, the DC-AC inverter 108 and a sliding mode controller 202.

In an aspect, the sliding mode controller 202 is a barrier function-based adaptive sliding mode controller (BFASMC). The sliding mode controller controls operation of the multisource hybrid energy storage system by applying a barrier-function-based controller gain to regulate a DC voltage at the DC bus to a reference voltage. The reference voltage is 400 V, for instance.

The sliding mode controller 202 switches a controller gain between a constant value and an adaptive barrier-function-based gain. The sliding mode controller 202 monitors a derivative of a barrier function and dynamically adjusts a control parameter based on the monitored derivative. An adaptation mechanism in the BF-based adaptive controller (i.e., BFASMC) maintains a balance between dynamically adjusting the control parameter, satisfying constraints, and effectively managing varying system conditions and uncertainties.

In an operative aspect, the adaptive barrier function gain, first increases till the time τ̅ using positive constant gain, until the output variable reaches a small neighborhood of zero φ/2. After time τ̅, gain switches to the barrier function BF that keeps the output variable in a predefined neighborhood of zero. The barrier-function-based controller gain is applied based on two types of functions (i.e., a positive-definite barrier function (PBF) or a positive semi-definite barrier function (PSBF)) assuming φ>0 and an even continuous function A_{d}: x∈]−φ, φ[→A_{d} (x)∈[d,∞], by increasing on [0,φ].

In the positive-definite barrier function (PBF),

$${A}_{pb} ( x ) = \frac{φ \overline{N}}{φ - \vert x \vert} , {A}_{pb} ( 0 ) = \overline{N} > 0$$

In the positive semi-definite barrier function (PSBF),

$${A}_{psb} ( x ) = \frac{\vert x \vert}{φ - \vert x \vert} , {A}_{psb} ( 0 ) = 0$$

where N̅ is a positive constant. When φ→0, then A→0. When the output variable is near the origin, i.e., (|x|)/φ<1 then A≈(|x|)/φ and this guarantees that state x will converge to zero. Graphical representation of A_{pb} (x) and A_{psb} (x) is shown in FIGS. 5A-5B.

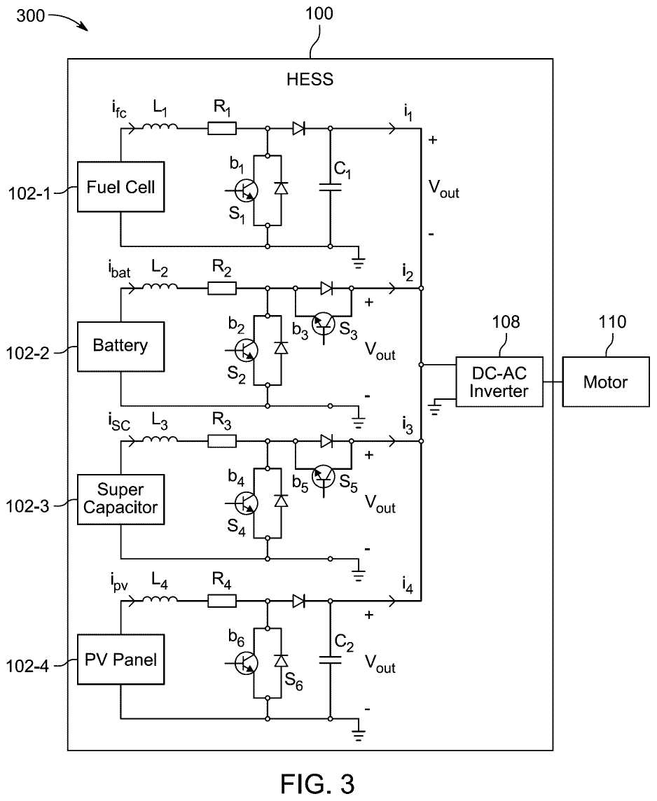

FIG. 3 illustrates an exemplary circuit diagram 300 of the HESS 100, according to certain embodiments.

As illustrated in FIG. 3, the first DC-DC converter (i.e., a DC-DC boost converter) 104-1 includes a resistor R₁, an inductor L₁, a capacitor C₁, an insulated gate bipolar transistor (IGBT) switch S₁, and a diode D₁. In an aspect, the insulated gate bipolar transistor (IGBT) switch is a type of semiconductor device that combines the features of both Metal-Oxide-Semiconductor Field-Effect Transistors (MOSFETs) and Bipolar Junction Transistors (BJTs). The IGBT is used to switch and control electrical power.

The second DC-DC converter (i.e., a DC-DC buck-boost converter) 104-2 includes a resistor R₂, an inductor L₂, two IGBT or Metal-Oxide-Semiconductor Field Effect Transistor (MOSFET) switches S₂ and S₃, and two diodes D₂ and D₃. In an aspect, the MOSFET switch is a semiconductor device used in electronic circuits to switch or amplify electrical signals. It uses a voltage applied to its gate terminal to control the current flow between its drain and source terminals.

The third DC-DC converter (i.e., a DC-DC buck-boost converter) 104-3 includes a resistor R₃, an inductor L₃, two IGBT switches S₄ and S₅, and two diodes D₄ and D₅.

The fourth DC-DC converter (i.e., a DC-DC boost converter) 104-4 includes a resistor R₄, an inductor L₄, a capacitor C₂, an IGBT switch S₆, and a diode D₆.

In an aspect, Kirchhoff's Current Law (KCL) and Kirchhoff's Voltage Law (KVL) are applied to the HESS 100 shown in FIG. 1 to obtain a mathematical model of the proposed HESS 100. In an aspect, the KCL states that the total current flowing into a junction (node) must equal the total current flowing out of the junction. The KCL is based on the principle of conservation of electric charge—charge cannot be created or destroyed at a node. In an aspect, the KVL states that the sum of all voltages around any closed loop or circuit is always equal to zero.

By applying KVL to the FC 102-1, the battery 102-2, the SC 102-3, and the PV panel 102-4 and KCL to the overall HESS 100 of FIG. 3, the equations are as follows:

$${v}_{fc} = {L}_{1} {\dot{x}}_{1} + {x}_{1} {R}_{1} + ( 1 - {b}_{1} ) {x}_{5} \qquad Equation ( 1 )$$

$${v}_{bat} = {L}_{2} {\dot{x}}_{2} + {x}_{2} {R}_{2} + {b}_{23} {x}_{5} \qquad Equation ( 2 )$$

$${v}_{sc} = {L}_{3} {\dot{x}}_{3} + {x}_{3} {R}_{3} + {b}_{45} {x}_{5} \qquad Equation ( 3 )$$

$${v}_{pv} = {L}_{4} {\dot{x}}_{4} + {x}_{4} {R}_{4} + ( 1 - {b}_{6} ) {x}_{5} \qquad Equation ( 4 )$$

$${i}_{o} = ( 1 - {b}_{1} ) {x}_{1} + {b}_{23} {x}_{2} + {b}_{45} {x}_{3} + ( 1 - {b}_{6} ) {x}_{4} - C {\dot{x}}_{5} \qquad Equation ( 5 )$$

where C=C₁+C₂, ν_{fc}, ν_{bat}, ν_{sc} and ν_{pν} are voltages of the FC 102-1, the battery 102-2, the SC 102-3, and the PV panel 102-4 respectively. i₀ is the load current. x1, x2, x3 and x4 are currents of the FC 102-1, the battery 102-2, the SC 102-3, and the PV panel 102-4, respectively. x₅ is the voltage at the DC bus 106. b₁, b₂₃, b₄₅ and b₆ are control inputs determining whether IGBT switches are ON or OFF. b₂₃ and b₄₅ are defined in equation (6) and equation (7), respectively:

$${b}_{23} = [ S ( 1 - {b}_{2} ) + ( 1 - S ) {b}_{3} ] \qquad Equation ( 6 )$$

$${b}_{45} = [ S ( 1 - {b}_{4} ) + ( 1 - S ) {b}_{5} ] \qquad Equation ( 7 )$$

where b₂, b₃, b₄ and b₅ are control inputs. S is a constant that can either be 0 or 1.

In an aspect, the buck-boost converter (i.e., the DC-DC buck-boost converter 104-2, the DC-DC buck-boost converter 104-3) works as a buck converter if S=0 and a boost converter if S=1.

Solving equations (1)-(5) for \dot{x}₁, \dot{x}₂, \dot{x}₃, \dot{x}₄ and \dot{x}₅, the resulting equations are as follows:

$${\dot{x}}_{1} = \frac{{v}_{fc}}{{L}_{1}} - {x}_{1} \frac{{R}_{1}}{{L}_{1}} - {x}_{5} \frac{( 1 - {b}_{1} )}{{L}_{1}} \qquad Equation ( 8 )$$

$${\dot{x}}_{2} = \frac{{v}_{bat}}{{L}_{2}} - {x}_{2} \frac{{R}_{2}}{{L}_{2}} - {x}_{5} \frac{{b}_{23}}{{L}_{2}} \qquad Equation ( 9 )$$

$${\dot{x}}_{3} = \frac{{v}_{sc}}{{L}_{3}} - {x}_{3} \frac{{R}_{3}}{{L}_{3}} - {x}_{5} \frac{{b}_{45}}{{L}_{3}} \qquad Equation ( 10 )$$

$${\dot{x}}_{4} = \frac{{v}_{pv}}{{L}_{4}} - {x}_{4} \frac{{R}_{4}}{{L}_{4}} - {x}_{5} \frac{( 1 - {b}_{6} )}{{L}_{4}} \qquad Equation ( 11 )$$

$${\dot{x}}_{5} = {x}_{1} \frac{( 1 - {b}_{1} )}{C} + {x}_{2} \frac{{b}_{23}}{C} + {x}_{3} \frac{{b}_{45}}{C} + {x}_{4} \frac{( 1 - {b}_{6} )}{C} - \frac{{i}_{o}}{C} \qquad Equation ( 12 )$$

Equations (8)-(12) represent the state-space model of the proposed HESS 100.

In an aspect, a dynamic system has a non-minimum phase behavior, so the DC bus voltage cannot be easily regulated to the desired voltage at the DC bus 106. Non-minimum phase behavior has a physical characteristic of dipping in the wrong direction before finally going in the right direction, and there are some fundamental physical limitations to the control that can be achieved for these non-minimum phase systems. The bigger the dip, the less robust the dynamic system will be for fast changes. So, non-minimum phase behavior should be considered for a more aggressive system. Either the non-minimum phase behavior is minimized to make the dynamic system as fast as possible, or some control is developed to compensate for this.

Therefore, an indirect approach is applied using the power balance equation as follows:

$${P}_{in} = {P}_{out} \qquad Equation ( 13 )$$

$${P}_{fc} + {P}_{bat} + {P}_{sc} + {P}_{pv} = {P}_{out}$$

where P_{fc}, P_{bat}, P_{sc}, and P_{pν} are powers of the FC 102-1, the battery 102-2, the SC 102-3, and the PV panel 102-4, respectively. Pₒᵤₜ is the load power.

Putting P_{fc}=ν_{fc}x_{1ref} in equation (13) and solving it for x_{1ref}, following power balance equation is obtained:

$${x}_{1 ref} = ω ( \frac{{P}_{out} - {P}_{bat} - {P}_{sc} - {P}_{pv}}{{v}_{fc}} ) \qquad Equation ( 14 )$$

where ω is a constant and represents different power losses, i.e., power loss due to inductances.

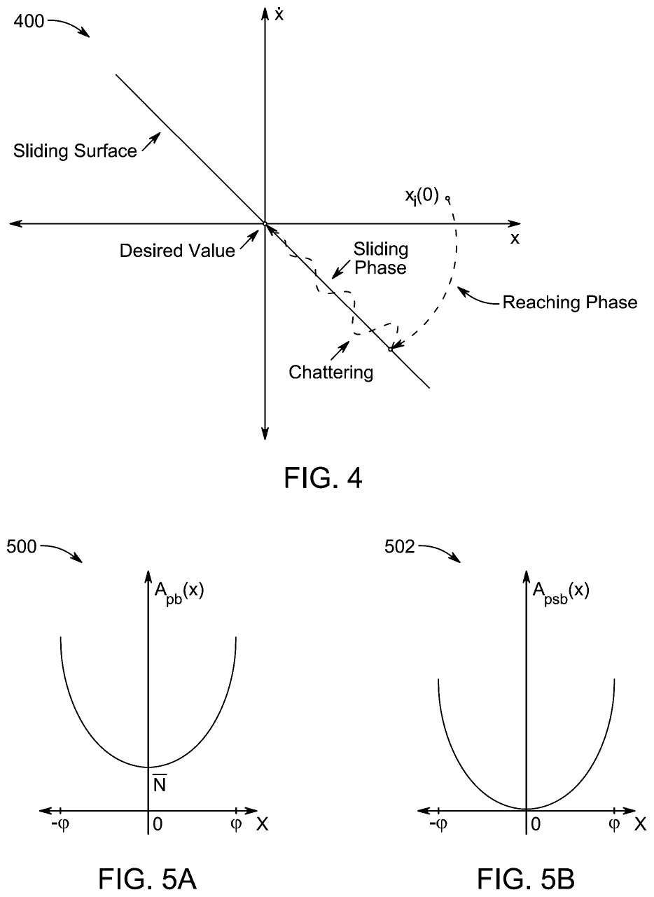

FIG. 4 illustrates an exemplary graphical representation 400 of the phase plane of a sliding mode controller (SMC), according to certain embodiments.

In an aspect, a robust controller maintains the desired performance of a system in the presence of any uncertainty or disturbance in the system parameter or environment. Such controllers are insensitive to disturbances in the system's behavior or output. SMC is primarily used to design robust controllers. The systems operating under complex or changing conditions must be robust. The SMC employs a non-linear variable structure control method that helps to stabilize the system trajectory.

As illustrated in FIG. 4, a sliding surface is drawn. A controller (e.g., SMC) is designed to bring the model to the sliding surface and help the system reach its desired value. The control law helps a system state with an initial value reach the sliding surface, and following that sliding surface, the state reaches its desired value (i.e., at x (0,0) (i.e., at origin) as shown in FIG. 4).

The error terms for each state are provided for them to attain their anticipated values as:

$${e}_{1} = {x}_{1} - {x}_{1 ref} \qquad Equation ( 15 )$$

$${e}_{2} = {x}_{2} - {x}_{2 ref} \qquad Equation ( 16 )$$

$${e}_{3} = {x}_{3} - {x}_{3 ref} \qquad Equation ( 17 )$$

$${e}_{4} = {x}_{4} - {x}_{4 ref} \qquad Equation ( 18 )$$

where x_{2ref}, x_{3ref}, and x_{4ref} are desired values of currents of the battery, the SC, and the PV panel. Taking time derivative of (15)-(18) and putting values of \dot{x}₁, \dot{x}₂, \dot{x}₃ and \dot{x}₄ from (8)-(11), the resulting equations are as follows:

$${\dot{e}}_{1} = \frac{{v}_{fc}}{{L}_{1}} - {x}_{1} \frac{{R}_{1}}{{L}_{1}} - {x}_{5} \frac{( 1 - {b}_{1} )}{{L}_{1}} - {\dot{x}}_{1 ref} \qquad Equation ( 19 )$$

$${\dot{e}}_{2} = \frac{{v}_{bat}}{{L}_{2}} - {x}_{2} \frac{{R}_{2}}{{L}_{2}} - {x}_{5} \frac{{b}_{23}}{{L}_{2}} - {\dot{x}}_{2 ref} \qquad Equation ( 20 )$$

$${\dot{e}}_{3} = \frac{{v}_{sc}}{{L}_{3}} - {x}_{3} \frac{{R}_{3}}{{L}_{3}} - {x}_{5} \frac{{b}_{45}}{{L}_{3}} - {\dot{x}}_{3 ref} \qquad Equation ( 21 )$$

$${\dot{e}}_{4} = \frac{{v}_{pv}}{{L}_{4}} - {x}_{4} \frac{{R}_{4}}{{L}_{4}} - {x}_{5} \frac{( 1 - {b}_{6} )}{{L}_{4}} - {\dot{x}}_{4 ref} \qquad Equation ( 22 )$$

Further, four sliding surfaces S₁, S₂, S₃ and S₄ are defined for respective control inputs, as results:

$${S}_{1} = {m}_{1} {e}_{1} \qquad Equation ( 23 )$$

$${S}_{2} = {m}_{2} {e}_{2} \qquad Equation ( 24 )$$

$${S}_{3} = {m}_{3} {e}_{3} \qquad Equation ( 25 )$$

$${S}_{4} = {m}_{4} {e}_{4} \qquad Equation ( 26 )$$

where m₁, m₂, m₃ and m₄ are positive constants.

Taking time derivative of equations (23)-(26) and putting values of ė₁, ė₂, ė₃ and ė₄ from equations (19)-(22), the resulting equations are as follows:

$${\dot{S}}_{1} = {m}_{1} ( \frac{{v}_{fc}}{{L}_{1}} - {x}_{1} \frac{{R}_{1}}{{L}_{1}} - {x}_{5} \frac{( 1 - {b}_{1} )}{{L}_{1}} - {\dot{x}}_{1 ref} ) \qquad Equation ( 27 )$$

$${\dot{S}}_{2} = {m}_{2} ( \frac{{v}_{bat}}{{L}_{2}} - {x}_{2} \frac{{R}_{2}}{{L}_{2}} - {x}_{5} \frac{{b}_{23}}{{L}_{2}} - {\dot{x}}_{2 ref} ) \qquad Equation ( 28 )$$

$${\dot{S}}_{3} = {m}_{3} ( \frac{{v}_{sc}}{{L}_{3}} - {x}_{3} \frac{{R}_{3}}{{L}_{3}} - {x}_{5} \frac{{b}_{45}}{{L}_{3}} - {\dot{x}}_{3 ref} ) \qquad Equation ( 29 )$$

$${\dot{S}}_{4} = {m}_{4} ( \frac{{v}_{pv}}{{L}_{4}} - {x}_{4} \frac{{R}_{4}}{{L}_{4}} - {x}_{5} \frac{( 1 - {b}_{6} )}{{L}_{4}} - {\dot{x}}_{4 ref} ) \qquad Equation ( 30 )$$

Now, a Lyapunov candidate function is considered for stability analysis:

$$V = \frac{1}{2} {S}_{1}^{2} + \frac{1}{2} {S}_{2}^{2} + \frac{1}{2} {S}_{3}^{2} + \frac{1}{2} {S}_{4}^{2} \qquad Equation ( 31 )$$

If the SMC satisfies the following conditions, then the system will be stable:

$$V ( x ) > 0$$

$$V ( 0 ) = 0$$

$$\dot{V} \leq 0$$

Take the time derivative of equation (31), as follows:

$$\dot{V} = {S}_{1} {\dot{S}}_{1} + {S}_{2} {\dot{S}}_{2} + {S}_{3} {\dot{S}}_{3} + {S}_{4} {\dot{S}}_{4} \qquad Equation ( 32 )$$

Putting the values of \dot{S}₁, \dot{S}₂, \dot{S}₃ and \dot{S}₄ from equations (27)-(30) in equation (32), the following equation is obtained:

$$\dot{V} = {S}_{1} [ {m}_{1} ( \frac{{v}_{f c}}{{L}_{1}} - {x}_{1} \frac{{R}_{1}}{{L}_{1}} - {x}_{5} \frac{( 1 - {b}_{1} )}{{L}_{1}} - {\dot{x}}_{1 ref} ) ] + {S}_{2} [ {m}_{2} ( \frac{{v}_{bat}}{{L}_{2}} - {x}_{2} \frac{{R}_{2}}{{L}_{2}} - {x}_{5} \frac{{b}_{23}}{{L}_{2}} - {\dot{x}}_{2 ref} ) ] + {S}_{3} [ {m}_{3} ( \frac{{v}_{s c}}{{L}_{3}} - {x}_{3} \frac{{R}_{3}}{{L}_{3}} - {x}_{5} \frac{{b}_{45}}{{L}_{3}} - {\dot{x}}_{3 ref} ) ] + {S}_{4} [ {m}_{4} ( \frac{{v}_{p v}}{{L}_{4}} - {x}_{4} \frac{{R}_{4}}{{L}_{4}} - {x}_{5} \frac{( 1 - {b}_{6} )}{{L}_{4}} - {\dot{x}}_{4 ref} ) ] \qquad Equation ( 33 )$$

To meet the Lyapunov stability criteria, consider the following constraints:

$$- {A}_{1} {\vert {S}_{1} \vert}^{α} sign ( \frac{{S}_{1}}{{ρ}_{1}} ) = {m}_{1} \frac{{v}_{f c}}{{L}_{1}} - {m}_{1} {x}_{1} \frac{{R}_{1}}{{L}_{1}} - {m}_{1} {x}_{5} \frac{( 1 - {b}_{1} )}{{L}_{1}} - {m}_{1} {\dot{x}}_{1 ref} \qquad Equation ( 34 )$$

$$- {A}_{2} {\vert {S}_{2} \vert}^{β} sign ( \frac{{S}_{2}}{{ρ}_{2}} ) = {m}_{2} \frac{{v}_{b a t}}{{L}_{2}} - {m}_{2} {x}_{2} \frac{{R}_{2}}{{L}_{2}} - {m}_{2} {x}_{5} \frac{{b}_{23}}{{L}_{2}} \qquad Equation ( 35 )$$

$$- {A}_{3} {\vert {S}_{3} \vert}^{γ} sign ( \frac{{S}_{3}}{{ρ}_{3}} ) = {m}_{3} \frac{{v}_{sc}}{{L}_{3}} - {m}_{3} {x}_{3} \frac{{R}_{3}}{{L}_{3}} - {m}_{3} {x}_{5} \frac{{b}_{45}}{{L}_{3}} - {m}_{3} {\dot{x}}_{3 ref} \qquad Equation ( 36 )$$

$$- {A}_{4} {\vert {S}_{4} \vert}^{ζ} sign ( \frac{{S}_{4}}{{ρ}_{4}} ) = {m}_{4} \frac{{v}_{p v}}{{L}_{4}} - {m}_{4} {x}_{4} \frac{{R}_{4}}{{L}_{4}} - {m}_{4} {x}_{5} \frac{( 1 - {b}_{6} )}{{L}_{4}} - {m}_{4} {\dot{x}}_{4 ref} \qquad Equation ( 37 )$$

$$where sign ( x ) = \{ \begin{matrix}- 1 , & {S}_{i} < 0 \\ 0 , & {S}_{i} = 0 \\ 1 , & {S}_{i} > 0\end{matrix}$$

$$for i = 1 , 2 , 3 , 4 , and {\dot{S}}_{i} = - {A}_{i} {\vert {S}_{i} \vert}^{ζ} sign ( \frac{{S}_{i}}{{ρ}_{i}} ) ,$$

for i=1,2,3,4, is a reaching law that makes control inputs achieve their desired values faster. |S₁|^{α}, |S₂|^{β}, |S₃|^{γ}, and |S₄|^{ζ} help control inputs to reach the sliding surface. α, β, γ and ζ are also positive constants. ρ₁, ρ₂, ρ₃ and ρ₄ support to reduce the chattering effect (as shown in FIG. 4). SMC gains A₁, A₂, A₃ and A₄ are design parameters that have positive constant values.

Now solving equations (34)-(37) for b₁, b₂₃, b₄₅ and b₆, following control laws represented in equations (38)-(41) are obtained:

$${b}_{1} = \frac{{L}_{1}}{{m}_{1} {x}_{5}} [ {m}_{1} {x}_{1} \frac{{R}_{1}}{{L}_{1}} - {m}_{1} \frac{{v}_{f c}}{{L}_{1}} + \frac{{m}_{1} {x}_{5}}{{L}_{1}} + {m}_{1} {\dot{x}}_{1 r e f} - {A}_{1} {\vert {S}_{1} \vert}^{α} sign ( \frac{{S}_{1}}{{ρ}_{1}} ) ] \qquad Equation ( 38 )$$

$${b}_{23} = \frac{{L}_{2}}{{m}_{2} {x}_{5}} [ - {m}_{2} {x}_{2} \frac{{R}_{2}}{{L}_{2}} + {m}_{2} \frac{{v}_{b a t}}{{L}_{2}} - {m}_{2} {\dot{x}}_{2 r e f} + {A}_{2} {\vert {S}_{2} \vert}^{β} sign ( \frac{{S}_{2}}{{ρ}_{2}} ) ] \qquad Equation ( 39 )$$

$${b}_{45} = \frac{{L}_{3}}{{m}_{3} {x}_{5}} [ - {m}_{3} {x}_{3} \frac{{R}_{3}}{{L}_{3}} + {m}_{3} \frac{{v}_{S C}}{{L}_{3}} - {m}_{3} {\dot{x}}_{3 r e f} + {A}_{3} {\vert {S}_{3} \vert}^{γ} sign ( \frac{{S}_{3}}{{ρ}_{3}} ) ] \qquad Equation ( 40 )$$

$${b}_{6} = \frac{{L}_{4}}{{m}_{4} {x}_{5}} [ {m}_{4} {x}_{4} \frac{{R}_{4}}{{L}_{4}} - {m}_{4} \frac{{v}_{p v}}{{L}_{4}} + \frac{{m}_{4} {x}_{5}}{{L}_{4}} + {m}_{4} {\dot{x}}_{4 r e f} - {A}_{4} {\vert {S}_{4} \vert}^{ζ} sign ( \frac{{S}_{4}}{{ρ}_{4}} ) ] \qquad Equation ( 41 )$$

Putting values of \dot{S}₁, \dot{S}₂, \dot{S}₃, and \dot{S}₄ from equations (34)-(37) in equation (33), as below:

$$\dot{V} = - {S}_{1} {A}_{1} {\vert {S}_{1} \vert}^{α} sign ( \frac{{S}_{1}}{{ρ}_{1}} ) - {S}_{2} {A}_{2} {\vert {S}_{2} \vert}^{β} sign ( \frac{{S}_{2}}{{ρ}_{2}} ) - {S}_{3} {A}_{3} {\vert {S}_{3} \vert}^{γ} sign ( \frac{{S}_{3}}{{ρ}_{3}} ) - {S}_{4} {A}_{4} {\vert {S}_{4} \vert}^{ζ} sign ( \frac{{S}_{4}}{{ρ}_{4}} ) \qquad Equation ( 42 )$$

Considering the properties of Aᵢ, Sᵢ and signum function, it is concluded that:

$$- {S}_{i} {A}_{i} {\vert {S}_{i} \vert}^{ζ} sign ( \frac{{S}_{i}}{{ρ}_{i}} ) \leq 0$$

So, from equation (42) and the above conclusion:

$$\dot{V} \leq 0$$

This shows that the SMC satisfies the stability conditions, and in finite time, all errors converge to zero.

In an integral sliding mode controller (ISMC), integral terms are added to errors in the ISMC to lower the steady-state error. In the SMC, system states reach the sliding surface after the reaching phase (as shown in FIG. 4) whereas in the ISMC, sliding mode exists from the start. The reaching phase of the ISMC is excluded by the addition of integral terms in errors that improve the robustness of the ISMC controller. Therefore, errors in the ISMC are defined as:

$${e}_{5} = \int ( {x}_{1} - {x}_{1 ref} ) dt \qquad Equation ( 43 )$$

$${e}_{6} = \int ( {x}_{2} - {x}_{2 ref} ) dt \qquad Equation ( 44 )$$

$${e}_{7} = \int ( {x}_{3} - {x}_{3 ref} ) dt \qquad Equation ( 45 )$$

$${e}_{8} = \int ( {x}_{4} - {x}_{4 ref} ) d t \qquad Equation ( 46 )$$

Taking time derivative of error terms in (43)-(46):

$$\dot{{e}_{5}} = {x}_{1} - {x}_{1 r e f} = {e}_{1} \qquad Equation ( 47 )$$

$$\dot{{e}_{6}} = {x}_{2} - {x}_{2 r e f} = {e}_{2} \qquad Equation ( 48 )$$

$$\dot{{e}_{7}} = {x}_{3} - {x}_{3 r e f} = {e}_{3} \qquad Equation ( 49 )$$

$$\dot{{e}_{8}} = {x}_{4} - {x}_{4 r e f} = {e}_{4} \qquad Equation ( 50 )$$

Sliding surfaces for the ISMC are as follows:

$${S}_{1} = {m}_{1} {e}_{1} + {m}_{5} {e}_{5} \qquad Equation ( 51 )$$

$${S}_{2} = {m}_{2} {e}_{2} + {m}_{6} {e}_{6} \qquad Equation ( 52 )$$

$${S}_{3} = {m}_{3} {e}_{3} + {m}_{7} {e}_{7} \qquad Equation ( 53 )$$

$${S}_{4} = {m}_{4} {e}_{4} + {m}_{8} {e}_{8} \qquad Equation ( 54 )$$

Taking the time derivative of the sliding surfaces in equations (51)-(54):

$${\dot{S}}_{1} = {m}_{1} \dot{{e}_{1}} + {m}_{5} \dot{{e}_{5}} \qquad Equation ( 55 )$$

$${\dot{S}}_{2} = {m}_{2} \dot{{e}_{2}} + {m}_{6} \dot{{e}_{6}} \qquad Equation ( 56 )$$

$${\dot{S}}_{3} = {m}_{3} \dot{{e}_{3}} + {m}_{7} \dot{{e}_{7}} \qquad Equation ( 57 )$$

$${\dot{S}}_{4} = {m}_{4} \dot{{e}_{4}} + {m}_{8} \dot{{e}_{8}} \qquad Equation ( 58 )$$

By putting the values of ė₁, ė₂, ė₃, ė₄, ė₅, ė₆, ė₇, and ė₈ from equations (19)-(22), equations (47)-(50) in equations (55)-(58), following equations are derived:

$$\dot{{S}_{1}} = {m}_{1} ( \frac{{v}_{f c}}{{L}_{1}} - {x}_{1} \frac{{R}_{1}}{{L}_{1}} - {x}_{5} \frac{( 1 - {b}_{1} )}{{L}_{1}} - {\dot{x}}_{1 ref} ) + {m}_{5} {e}_{1} \qquad Equation ( 59 )$$

$$\dot{{S}_{2}} = {m}_{2} ( \frac{{v}_{b a t}}{{L}_{2}} - {x}_{2} \frac{{R}_{2}}{{L}_{2}} - {x}_{5} \frac{{b}_{23}}{{L}_{2}} - {\dot{x}}_{2 ref} ) \qquad Equation ( 60 )$$

$$\dot{{S}_{3}} = {m}_{3} ( \frac{{v}_{sc}}{{L}_{3}} - {x}_{3} \frac{{R}_{3}}{{L}_{3}} - {x}_{5} \frac{{b}_{45}}{{L}_{3}} - {\dot{x}}_{3 ref} ) \qquad Equation ( 61 )$$

$$\dot{{S}_{4}} = {m}_{4} ( \frac{{v}_{p v}}{{L}_{4}} - {x}_{4} \frac{{R}_{4}}{{L}_{4}} - {x}_{5} \frac{( 1 - {b}_{6} )}{{L}_{4}} - {\dot{x}}_{4 ref} ) + {m}_{8} {e}_{4} \qquad Equation ( 62 )$$

For stability analysis, taking the time derivative of the Lyapunov candidate function:

$$\dot{V} = {S}_{1} \dot{{S}_{1}} + {S}_{2} \dot{{S}_{2}} + {S}_{3} \dot{{S}_{3}} + {S}_{4} \dot{{S}_{4}} \qquad Equation ( 63 )$$

Putting the values of \dot{S}₁, \dot{S}₂, \dot{S}₃, and \dot{S}₄ from equations (59)-(62) in equation (63), as follows:

$$\dot{V} = {S}_{1} [ {m}_{1} ( \frac{{v}_{f c}}{{L}_{1}} - {x}_{1} \frac{{R}_{1}}{{L}_{1}} - {x}_{5} \frac{( 1 - {b}_{1} )}{{L}_{1}} - {\dot{x}}_{1 ref} ) + {m}_{5} {e}_{1} ] + {S}_{2} [ {m}_{2} ( \frac{{v}_{b a t}}{{L}_{2}} - {x}_{2} \frac{{R}_{2}}{{L}_{2}} - {x}_{5} \frac{{b}_{23}}{{L}_{2}} - {\dot{x}}_{2 ref} ) + {m}_{6} {e}_{2} ] + {S}_{3} [ {m}_{3} ( \frac{{v}_{sc}}{{L}_{3}} - {x}_{3} \frac{{R}_{3}}{{L}_{3}} - {x}_{5} \frac{{b}_{45}}{{L}_{3}} - {\dot{x}}_{3 ref} ) + {m}_{7} {e}_{3} ] + {S}_{4} [ {m}_{4} ( \frac{{v}_{p v}}{{L}_{4}} - {x}_{4} \frac{{R}_{4}}{{L}_{4}} - {x}_{5} \frac{( 1 - {b}_{6} )}{{L}_{4}} - {\dot{x}}_{4 ref} ) + {m}_{8} {e}_{4} ] \qquad Equation ( 64 )$$

For making \dot{V}≤0, let,

$$- {A}_{1} {\vert {S}_{1} \vert}^{α} sign ( \frac{{S}_{1}}{{ρ}_{1}} ) = {m}_{1} \frac{{v}_{f c}}{{L}_{1}} - {m}_{1} {x}_{1} \frac{{R}_{1}}{{L}_{1}} - {m}_{1} {x}_{5} \frac{( 1 - {b}_{1} )}{{L}_{1}} + {m}_{5} {e}_{1} - {m}_{1} {\dot{x}}_{1 ref} \qquad Equation ( 65 )$$

$$- {A}_{2} {\vert {S}_{2} \vert}^{β} sign ( \frac{{S}_{2}}{{ρ}_{2}} ) = {m}_{2} \frac{{v}_{b a t}}{{L}_{2}} - {m}_{2} {x}_{2} \frac{{R}_{2}}{{L}_{2}} - {m}_{2} {x}_{5} \frac{{b}_{23}}{{L}_{2}} + {m}_{6} {e}_{2} - {m}_{2} {\dot{x}}_{2 ref} \qquad Equation ( 66 )$$

$$- {A}_{3} {\vert {S}_{3} \vert}^{γ} sign ( \frac{{S}_{3}}{{ρ}_{3}} ) = {m}_{3} \frac{{v}_{sc}}{{L}_{3}} - {m}_{3} {x}_{3} \frac{{R}_{3}}{{L}_{3}} - {m}_{3} {x}_{5} \frac{{b}_{45}}{{L}_{3}} + {m}_{7} {e}_{3} - {m}_{3} {\dot{x}}_{3 ref} \qquad Equation ( 67 )$$

$$- {A}_{4} {\vert {S}_{4} \vert}^{ζ} sign ( \frac{{s}_{4}}{{ρ}_{4}} ) = {m}_{4} \frac{{v}_{p v}}{{L}_{4}} - {m}_{4} {x}_{4} \frac{{R}_{4}}{{L}_{4}} - {m}_{4} {x}_{5} \frac{( 1 - {b}_{6} )}{{L}_{4}} + {m}_{8} {e}_{4} - {m}_{4} {\dot{x}}_{4 ref} \qquad Equation ( 68 )$$

Solving equations (65)-(68) for b₁, b₂₃, b₄₅, and b₆, the following control laws represented in equations (69)-(72) are obtained:

$${b}_{1} = \frac{{L}_{1}}{{m}_{1} {x}_{5}} [ {m}_{1} {x}_{1} \frac{{R}_{1}}{{L}_{1}} - {m}_{1} \frac{{v}_{f c}}{{L}_{1}} + \frac{{m}_{1} {x}_{5}}{{L}_{1}} - {m}_{5} {e}_{1} + {m}_{1} {\dot{x}}_{1 ref} - {A}_{1} {\vert {S}_{1} \vert}^{α} sign ( \frac{{S}_{1}}{{ρ}_{1}} ) ] \qquad Equation ( 69 )$$

$${b}_{23} = \frac{{L}_{2}}{{m}_{2} {x}_{5}} [ - {m}_{2} {x}_{2} \frac{{R}_{2}}{{L}_{2}} + {m}_{2} \frac{{v}_{b a t}}{{L}_{2}} + {m}_{6} {e}_{2} - {m}_{2} {\dot{x}}_{2 ref} + {A}_{2} {\vert {S}_{2} \vert}^{β} sign ( \frac{{S}_{2}}{{ρ}_{2}} ) ] \qquad Equation ( 70 )$$

$${b}_{45} = \frac{{L}_{3}}{{m}_{3} {x}_{5}} [ - {m}_{3} {x}_{3} \frac{{R}_{3}}{{L}_{3}} + {m}_{3} \frac{{v}_{sc}}{{L}_{3}} + {m}_{7} {e}_{3} - {m}_{3} {\dot{x}}_{3 ref} + {A}_{3} {\vert {S}_{3} \vert}^{γ} sign ( \frac{{S}_{3}}{{ρ}_{3}} ) ] \qquad Equation ( 71 )$$

$${b}_{6} = \frac{{L}_{4}}{{m}_{4} {x}_{5}} [ {m}_{4} {x}_{4} \frac{{R}_{4}}{{L}_{4}} - {m}_{4} \frac{{v}_{p v}}{{L}_{4}} + \frac{{m}_{4} {x}_{5}}{{L}_{4}} - {m}_{8} {e}_{4} + {m}_{4} {\dot{x}}_{4 ref} - {A}_{4} {\vert {S}_{4} \vert}^{ζ} sign ( \frac{{S}_{4}}{{ρ}_{4}} ) ] \qquad Equation ( 72 )$$

Putting equations (65)-(68) in equation (64):

$$\dot{V} = - {S}_{1} {A}_{1} {\vert {S}_{1} \vert}^{∝} sign ( \frac{{S}_{1}}{{ρ}_{1}} ) - {S}_{2} {A}_{2} {\vert {S}_{2} \vert}^{β} sign ( \frac{{S}_{2}}{{ρ}_{2}} ) - {S}_{3} {A}_{3} {\vert {S}_{3} \vert}^{γ} sign ( \frac{{S}_{3}}{{ρ}_{3}} ) - {S}_{4} {A}_{4} {\vert {S}_{4} \vert}^{ζ} sign ( \frac{{S}_{4}}{{ρ}_{4}} ) \qquad Equation ( 73 )$$

Using equation (73), the following conclusion can be drawn with the signum function under consideration:

$$\dot{V} \leq 0$$

Therefore, the ISMC is asymptotically stable, and in finite time, all errors converge to zero.

In a double integral sliding mode controller (DISMC), the chattering effect is removed in addition to a steady-state error by adding another integral term. Therefore, double integral terms are added to errors in the DISMC.

Errors are defined as:

$${e}_{9} = \int [ \int ( {x}_{1} - {x}_{1 ref} ) dt ] dt \qquad Equation ( 74 )$$

$${e}_{10} = \int [ \int ( {x}_{2} - {x}_{2 ref} ) dt ] dt \qquad Equation ( 75 )$$

$${e}_{11} = \int [ \int ( {x}_{3} - {x}_{3 ref} ) dt ] dt \qquad Equation ( 76 )$$

$${e}_{12} = \int [ \int ( {x}_{4} - {x}_{4 ref} ) dt ] dt \qquad Equation ( 77 )$$

Taking time derivative of error terms in equations (74)-(77):

$$\dot{{e}_{9}} = \int ( {x}_{1} - {x}_{1 ref} ) dt = {e}_{5} \qquad Equation ( 78 )$$

$$\dot{{e}_{10}} = \int ( {x}_{2} - {x}_{2 ref} ) dt = {e}_{6} \qquad Equation ( 79 )$$

$$\dot{{e}_{11}} = \int ( {x}_{3} - {x}_{3 ref} ) dt = {e}_{7} \qquad Equation ( 80 )$$

$$\dot{{e}_{12}} = \int ( {x}_{4} - {x}_{4 ref} ) dt = {e}_{8} \qquad Equation ( 81 )$$

Sliding surfaces for the double ISMC are defined as:

$${S}_{1} = {m}_{1} {e}_{1} + {m}_{5} {e}_{5} + {m}_{9} {e}_{9} \qquad Equation ( 82 )$$

$${S}_{2} = {m}_{2} {e}_{2} + {m}_{6} {e}_{6} + {m}_{10} {e}_{10} \qquad Equation ( 83 )$$

$${S}_{3} = {m}_{3} {e}_{3} + {m}_{7} {e}_{7} + {m}_{11} {e}_{11} \qquad Equation ( 84 )$$

$${S}_{4} = {m}_{4} {e}_{4} + {m}_{8} {e}_{8} + {m}_{12} {e}_{12} \qquad Equation ( 85 )$$

Taking a time derivative of the sliding surfaces in equations (82)-(85) yields the following equations:

$${\dot{S}}_{1} = {m}_{1} \dot{{e}_{1}} + {m}_{5} \dot{{e}_{5}} + {m}_{9} \dot{{e}_{9}} \qquad Equation ( 86 )$$

$${\dot{S}}_{2} = {m}_{2} \dot{{e}_{2}} + {m}_{6} \dot{{e}_{6}} + {m}_{10} \dot{{e}_{10}} \qquad Equation ( 87 )$$

$${\dot{S}}_{3} = {m}_{3} \dot{{e}_{3}} + {m}_{7} \dot{{e}_{7}} + {m}_{11} \dot{{e}_{11}} \qquad Equation ( 88 )$$

$${\dot{S}}_{4} = {m}_{4} \dot{{e}_{4}} + {m}_{8} \dot{{e}_{8}} + {m}_{12} \dot{{e}_{12}} \qquad Equation ( 89 )$$

Put the values of

$$\dot{{e}_{1}} , \dot{{e}_{2}} , \dot{{e}_{3}} , \dot{{e}_{4}} , \dot{{e}_{5}} , \dot{{e}_{6}} , \dot{{e}_{7}} , \dot{{e}_{8}} , \dot{{e}_{9}} , \dot{{e}_{10}} , \dot{{e}_{11}} , and \dot{{e}_{12}}$$

from equations (19)-(22), equations (47)-(50), equations (78)-(81) in equations (86)-(89), and then enter those values of \dot{S}₁, \dot{S}₂, \dot{S}₃ and \dot{S}₄ in the time derivative of the Lyapunov candidate function to derive equation (90):

$$\dot{V} = {S}_{1} \dot{{S}_{1}} + {S}_{2} \dot{{S}_{2}} + {S}_{3} \dot{{S}_{3}} + {S}_{4} \dot{{S}_{4}} \qquad Equation ( 90 )$$

$$\dot{V} = {S}_{1} [ {m}_{1} ( \frac{{v}_{fc}}{{L}_{1}} - {x}_{1} \frac{{R}_{1}}{{L}_{1}} - {x}_{5} \frac{( 1 - {b}_{1} )}{{L}_{1}} - {\dot{x}}_{1 ref} ) + {m}_{5} {e}_{1} + {m}_{9} {e}_{5} ] + {S}_{2} [ {m}_{2} ( \frac{{v}_{bat}}{{L}_{2}} - {x}_{2} \frac{{R}_{2}}{{L}_{2}} - {x}_{5} \frac{{b}_{23}}{{L}_{2}} - {\dot{x}}_{2 ref} ) + {m}_{6} {e}_{2} + {m}_{10} {e}_{6} ] + {S}_{3} [ {m}_{3} ( \frac{{v}_{sc}}{{L}_{3}} - {x}_{3} \frac{{R}_{3}}{{L}_{3}} - {x}_{5} \frac{{b}_{45}}{{L}_{3}} - {\dot{x}}_{3 ref} ) + {m}_{7} {e}_{3} + {m}_{11} {e}_{7} ] + {S}_{4} [ {m}_{4} ( \frac{{v}_{pv}}{{L}_{4}} - {x}_{4} \frac{{R}_{4}}{{L}_{4}} - {x}_{5} \frac{( 1 - {b}_{6} )}{{L}_{4}} - {\dot{x}}_{4 ref} ) + {m}_{8} {e}_{4} + {m}_{12} {e}_{8} ]$$

Now using the constraints same as used above in equations (65)-(68) and solving the equations for b₁, b₂₃, b₄₅ and b₆, as follows:

$${b}_{1} = \frac{{L}_{1}}{{m}_{1} {x}_{5}} [ {m}_{1} {x}_{1} \frac{{R}_{1}}{{L}_{1}} - {m}_{1} \frac{{v}_{fc}}{{L}_{1}} + \frac{{m}_{1} {x}_{5}}{{L}_{1}} - {m}_{5} {e}_{1} - {m}_{9} {e}_{5} + {m}_{1} {\dot{x}}_{1 ref} - {A}_{1} {\vert {S}_{1} \vert}^{∝} sign ( \frac{{S}_{1}}{{ρ}_{1}} ) ] \qquad Equation ( 91 )$$

$${b}_{23} = \frac{{L}_{2}}{{m}_{2} {x}_{5}} [ - {m}_{2} {x}_{2} \frac{{R}_{2}}{{L}_{2}} + {m}_{2} \frac{{v}_{bat}}{{L}_{2}} + {m}_{6} {e}_{2} + {m}_{10} {e}_{6} - {m}_{2} {\dot{x}}_{2 ref} + {A}_{2} {\vert {S}_{2} \vert}^{β} sign ( \frac{{S}_{2}}{{ρ}_{2}} ) ] \qquad Equation ( 92 )$$

$${b}_{45} = \frac{{L}_{3}}{{m}_{3} {x}_{5}} [ - {m}_{3} {x}_{3} \frac{{R}_{3}}{{L}_{3}} + {m}_{3} \frac{{v}_{sc}}{{L}_{3}} + {m}_{7} {e}_{3} + {m}_{11} {e}_{7} - {m}_{3} {\dot{x}}_{3 ref} + {A}_{3} {\vert {S}_{3} \vert}^{γ} sign ( \frac{{S}_{3}}{{ρ}_{3}} ) ] \qquad Equation ( 93 )$$

$${b}_{6} = \frac{{L}_{4}}{{m}_{4} {x}_{5}} [ {m}_{4} {x}_{4} \frac{{R}_{4}}{{L}_{4}} - {m}_{4} \frac{{v}_{pv}}{{L}_{4}} + \frac{{m}_{4} {x}_{5}}{{L}_{4}} - {m}_{8} {e}_{4} - {m}_{12} {e}_{8} + {m}_{4} {\dot{x}}_{4 ref} - {A}_{4} {\vert {S}_{4} \vert}^{ζ} sign ( \frac{{S}_{4}}{{ρ}_{4}} ) ] \qquad Equation ( 94 )$$

Equations (91)-(94) represent the control laws b₁, b₂₃, b₄₅, and b₆, respectively. Utilizing equations (65)-(68), signum function and Lyapunov candidate function, equation (95) is derived:

$$\dot{V} = - {S}_{1} {A}_{1} {\vert {S}_{1} \vert}^{∝} sign ( \frac{{S}_{1}}{{ρ}_{1}} ) - {S}_{2} {A}_{2} {\vert {S}_{2} \vert}^{β} si - {S}_{3} {A}_{3} {\vert {S}_{3} \vert}^{γ} sign ( \frac{{S}_{3}}{{ρ}_{3}} ) - {S}_{4} {A}_{4} {\vert {S}_{4} \vert}^{ζ} sign ( \frac{{S}_{4}}{{ρ}_{4}} ) \leq 0 \qquad Equation ( 95 )$$

Equation (95) shows that the system is stable.

FIGS. 5A-5B illustrate exemplary graphical representations 500, 502 of Apb (x) and Apsb (x), respectively, according to certain embodiments.

The barrier function adaptive sliding mode controller (BFASMC) 202 removes the chattering problem occurring in the conventional controllers (i.e., SMC, ISMC, DISMC) and helps in gain selection. The BFASMC 202 enables finite-time convergence of output variable to a predefined neighborhood of zero. The gain is not overestimated, and low pass filter or disturbance bounds are not required. The control law defined for DC bus voltage is a function of state variables and varies with time, as shown in equation (12).

The BFASMC 202 uses an adaptive barrier function gain that switch between adaptive gain and constant values. The adaptation mechanism in a barrier function-based adaptive controller continuously monitors the derivative of the barrier function. It uses the information from the barrier function to dynamically adjust the control law and parameters. The adaptation mechanism in BF-based adaptive controller helps balance achieving control objectives and satisfying the constraint, making it particularly useful for varying system conditions and uncertainties.

The adaptive barrier function gain first increases till the time t̅ using positive constant gain, until the output variable reaches a small neighborhood of zero

$$\frac{φ}{2} .$$

After time t̅, gain switches to a barrier function (BF) that keep the output variable in a predefined neighborhood of zero. The BF is defined in two ways, assuming that, φ>0 and an even continuous function A_{d}: x∈]−φ, φ[→A_{d} (x)∈[d, ∞], by increasing on [0, φ]:

### 1) Positive-Definite Barrier Function (PBF)

$${A}_{pb} ( x ) = \frac{φ \overline{N}}{φ - \vert x \vert} \qquad Equation ( 96 )$$

$${A}_{pb} ( 0 ) = \overline{N} > 0$$

### 2) Positive Semi-Definite Barrier Function (PSBF)

$${A}_{psb} ( x ) = \frac{\vert x \vert}{φ - \vert x \vert} \qquad Equation ( 97 )$$

$${A}_{psb} ( 0 ) = 0$$

where N̅ is a positive constant. When φ→0 then A→0. When the output variable is near the origin,

$$i . e . , \frac{\vert x \vert}{φ} < 1$$

then

$$A \approx \frac{\vert x \vert}{φ} .$$

This ensures that state x will converge to zero. Graphical representations (500, 502) of A_{pb} (x) and A_{psb} (x) is illustrated in FIGS. 5A and 5B, respectively.

In the barrier function-based adaptive SMC (BFASMC) 202, the following equations define errors for the stable working of the system:

$${S}_{1} = {x}_{1} - {x}_{1 ref} \qquad Equation ( 98 )$$

$${S}_{2} = {x}_{2} - {x}_{2 ref} \qquad Equation ( 99 )$$

$${S}_{3} = {x}_{3} - {x}_{3 ref} \qquad Equation ( 100 )$$

$${S}_{4} = {x}_{4} - {x}_{4 ref} \qquad Equation ( 101 )$$

Taking time derivative of equations (98)-(101) and putting the values of \dot{x}₁, \dot{x}₂, \dot{x}₃ and \dot{x}₄ from equations (8)-(11):

$${\dot{S}}_{1} = \frac{{v}_{fc}}{{L}_{1}} - {x}_{1} \frac{{R}_{1}}{{L}_{1}} - {x}_{5} \frac{( 1 - {b}_{1} )}{{L}_{1}} - {\dot{x}}_{1 ref} + {θ}_{1} \qquad Equation ( 102 )$$

$${\dot{S}}_{2} = \frac{{v}_{b a t}}{{L}_{2}} - {x}_{2} \frac{{R}_{2}}{{L}_{2}} - {x}_{5} \frac{{b}_{23}}{{L}_{2}} - {\dot{x}}_{2 ref} + {θ}_{2} \qquad Equation ( 103 )$$

$${\dot{S}}_{3} = \frac{{v}_{sc}}{{L}_{3}} - {x}_{3} \frac{{R}_{3}}{{L}_{3}} - {x}_{5} \frac{{b}_{45}}{{L}_{3}} - {\dot{x}}_{3 ref} + {θ}_{3} \qquad Equation ( 104 )$$

$${\dot{S}}_{4} = \frac{{v}_{pv}}{{L}_{4}} - {x}_{4} \frac{{R}_{4}}{{L}_{4}} - {x}_{5} \frac{( 1 - {b}_{6} )}{{L}_{4}} - {\dot{x}}_{4 ref} + {θ}_{4} \qquad Equation ( 105 )$$

Where θ₁, θ₂, θ₃, and θ₄ are untilled bounds, and the controller adaptively reduces these factors. To converge error terms to zero, the following BFs are defined for \dot{S}₁, \dot{S}₂, \dot{S}₃, and \dot{S}₄:

$${\dot{S}}_{1} = - {A}_{1} \vert {S}_{1} \vert sign ( {S}_{1} ) \qquad Equation ( 106 )$$

$${\dot{S}}_{2} = - {A}_{2} \vert {S}_{2} \vert sign ( {S}_{2} ) \qquad Equation ( 107 )$$

$${\dot{S}}_{3} = - {A}_{3} \vert {S}_{3} \vert sign ( {S}_{3} ) \qquad Equation ( 108 )$$

$${\dot{S}}_{4} = - {A}_{4} \vert {S}_{4} \vert sign ( {S}_{4} ) \qquad Equation ( 109 )$$

where, A₁, A₂, A₃, and A₄ are adaptive gains. The A₁, A₂, A₃ and A₄ are defined in equation (110) using equations (96)-(97), as follows:

$${A}_{i} ( t ) = \{ \begin{matrix}{A}_{pb} ( t ) , \dot{{A}_{pb}} ( t ) = \overline{N} \vert {S}_{i} ( t ) \vert , & 0 < t < \overline{t} \\ {A}_{psb} \vert {S}_{i} ( t ) \vert , & t > \overline{t}\end{matrix} \qquad Equation ( 110 )$$

$$for i = 1 , 2 , 3 , 4$$

A control input b₁ is defined in equation (111) using equations (102) and (106) as:

$$- {A}_{1} \vert {S}_{1} \vert sign ( {S}_{1} ) = \frac{{v}_{fc}}{{L}_{1}} - {x}_{1} \frac{{R}_{1}}{{L}_{1}} - {x}_{5} \frac{( 1 - {b}_{1} )}{{L}_{1}} - {\dot{x}}_{1 ref} - \frac{{x}_{5}}{{L}_{1}} + {x}_{5} \frac{{b}_{1}}{{L}_{1}} = {x}_{1} \frac{{R}_{1}}{{L}_{1}} - \frac{{v}_{fc}}{{L}_{1}} + {\dot{x}}_{1 ref} - {A}_{1} \vert {S}_{1} \vert sign ( {S}_{1} ) \qquad Equation ( 111 )$$

$${b}_{1} = 1 + \frac{{L}_{1}}{{x}_{5}} [ {x}_{1} \frac{{R}_{1}}{{L}_{1}} - \frac{{v}_{fc}}{{L}_{1}} + {\dot{x}}_{1 ref} - {A}_{1} \vert {S}_{1} \vert sign ( {S}_{1} ) ]$$

A control input b₂₃ is defined in equation (112) using equations (103) and (107) as:

$$- {A}_{2} \vert {S}_{2} \vert sign ( {S}_{2} ) = \frac{{v}_{bat}}{{L}_{2}} - {x}_{2} \frac{{R}_{2}}{{L}_{2}} - {x}_{5} \frac{{b}_{23}}{{L}_{2}} - {\dot{x}}_{2 ref} \qquad Equation ( 112 )$$

$${x}_{5} \frac{{b}_{23}}{{L}_{2}} = - {x}_{2} \frac{{R}_{2}}{{L}_{2}} + \frac{{v}_{bat}}{{L}_{2}} - {\dot{x}}_{2 ref} + {A}_{2} \vert {S}_{2} \vert sign ( {S}_{2} )$$

$${b}_{23} = \frac{{L}_{2}}{{x}_{5}} [ - {x}_{2} \frac{{R}_{2}}{{L}_{2}} + \frac{{v}_{bat}}{{L}_{2}} - {\dot{x}}_{2 ref} + {A}_{2} \vert {S}_{2} \vert sign ( {S}_{2} ) ]$$

Similarly, control inputs b₄₅ and b₆ are defined in equations (113)-(114) using equations (104) and (108) and (105) and (109), respectively, as:

$${b}_{45} = \frac{{L}_{3}}{{x}_{5}} [ - {x}_{3} \frac{{R}_{3}}{{L}_{3}} + \frac{{v}_{sc}}{{L}_{3}} - {\dot{x}}_{3 ref} + {A}_{3} \vert {S}_{3} \vert sign ( {S}_{3} ) ] \qquad Equation ( 113 )$$

$${b}_{6} = 1 + \frac{{L}_{4}}{{x}_{5}} [ {x}_{4} \frac{{R}_{4}}{{L}_{4}} - \frac{{v}_{pv}}{{L}_{4}} + {\dot{x}}_{4 ref} - {A}_{4} \vert {S}_{4} \vert sign ( {S}_{4} ) ] \qquad Equation ( 114 )$$

There exists t̅ the smallest root of equation

$$\vert S ( t ) \vert \leq \frac{φ}{2} ,$$

for any S(0) and φ>0, such that for all t≥t̅, the inequality |S(t)|<φ holds. Therefore, the stability of the proposed controller (i.e., BFASMC) is demonstrated through the following equations.

For the Lyapunov stability analysis of the proposed controller (i.e., BFASMC), consider the following Lyapunov candidate function:

$${V}_{i} ( {S}_{i} ( t ) , {A}_{i} ( {S}_{i} ( t ) ) ) = \frac{1}{2} {S}_{i}^{2} ( t ) + \frac{1}{2} {( {A}_{i} ( {S}_{i} ( t ) ) - {A}_{i} ( 0 ) )}^{2} \qquad Equation ( 115 )$$

By taking a time derivative of equation (115), the equation (116) is obtained as shown below:

$${\dot{V}}_{i} ( {S}_{i} ( t ) , {A}_{i} ( {S}_{i} ( t ) ) ) \leq - {σ}_{i} {V}_{i}^{\frac{1}{2}} ( {S}_{i} ( t ) , {A}_{i} ( {S}_{i} ( t ) ) ) \qquad Equation ( 116 )$$

where

$${σ}_{i} > 0 , {V}_{i}^{\frac{1}{2}} ( {S}_{i} ( t ) , {A}_{i} ( {S}_{i} ( t ) ) ) \geq 0 ,$$

so equation (116) can be written as Equation (117):

$${\dot{V}}_{i} ( {S}_{i} ( t ) , {A}_{i} ( {S}_{i} ( t ) ) ) \leq 0 \qquad Equation ( 117 )$$

The equation (117) proves the stability of the sliding variables, Sᵢ for i=1, 2, 3, 4.

The final stability of the state is given by equation (118):

$$V = \frac{1}{2} [ {S}_{1}^{2} ( t ) + {( {A}_{1} ( {S}_{1} ( t ) ) - {A}_{1} ( 0 ) )}^{2} ] + \frac{1}{2} [ {S}_{2}^{2} ( t ) + {( {A}_{2} ( {S}_{2} ( t ) ) - {A}_{2} ( 0 ) )}^{2} ] + \frac{1}{2} [ {S}_{3}^{2} ( t ) + {( {A}_{3} ( {S}_{3} ( t ) ) - {A}_{3} ( 0 ) )}^{2} ] + \frac{1}{2} [ {S}_{4}^{2} ( t ) + {( {A}_{4} ( {S}_{4} ( t ) ) - {A}_{4} ( 0 ) )}^{2} ] \qquad Equation ( 118 )$$

Taking a time derivative of equation (118) and using equation (115):

$$\dot{V} = {\dot{V}}_{1} ( {S}_{1} ( t ) , {A}_{1} ( {S}_{1} ( t ) ) ) + {\dot{V}}_{2} ( {S}_{2} ( t ) , {A}_{2} ( {S}_{2} ( t ) ) ) + {\dot{V}}_{3} ( {S}_{3} ( t ) , {A}_{3} ( {S}_{3} ( t ) ) ) + {\dot{V}}_{4} ( {S}_{4} ( t ) , {A}_{4} ( {S}_{4} ( t ) ) )$$

Using equation (117):

$$\dot{V} \leq 0$$

Therefore, the proposed controller (i.e., BFASMC) satisfies stability conditions for Lyapunov stability analysis and is stable. The Lyapunov stability analysis has proven the stability of the proposed controller (i.e., BFASMC).

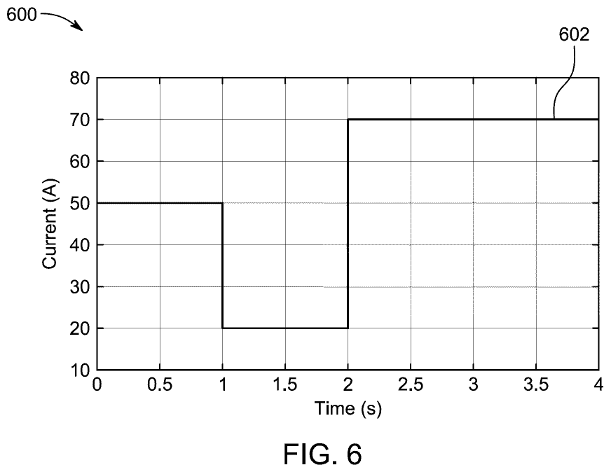

FIG. 6 illustrates an exemplary graphical representation 600 of load profile (iₒ) 602, according to certain embodiments.

The performance of BFASMC-based HESS 100 including the FC 102-1, the battery 102-2, the SC 102-3, and the PV panel 102-4 is tested and evaluated by a plurality of simulation and real-time analysis. The simulation and real-time analysis are performed in MATLAB/Simulink and dSPACE RTI1202, respectively.

The specifications of the plurality of DC-DC converters 104 and energy sources 102 are listed in Table 1 and Table 2, respectively. The design parameters of the controllers are mentioned in Table 3. FIG. 6 shows a varying load profile (iₒ) 602. In an aspect, the load profile is used as a perturbation to be added to the control signal to test the robustness of the proposed controller (i.e., BFASMC).

TABLE 1
NOMINAL PARAMETERS OF DC-DC CONVERTERS

| Parameters | Values |
|---|---|
| Inductances L₁, L₂, L₃ and L₄ | 3.3 mH |
| Resistances R₁, R₂, R₃ and R₄ | 20 mΩ |
| Capacitors C₁ and C₂ | 1.66 mF |
| ω | 1.0004 |

TABLE 2
NOMINAL PARAMETERS OF POWER SOURCES

| Sources | Specifications |
|---|---|
| Fuel cell | 350 V, 250 A, 34 KW |
| Battery | 288 Vdc, |
| | 13.9 Ah, Li-ion |
| Super Capacitor | 250 Vdc, 2700 F |
| PV Panel | 275 V, 5 A, 1.3 KW |

TABLE 3
DESIGNED CONTROLLER'S GAINS

| Controller | Design Parameters | Values |
|---|---|---|
| SMC | A₁, A₂, A₃, A₄ | 3000, |
| | | 2000, |
| | | 1500, |
| | | 1500 |
| | m₁, m₂, m₃, m₄ | 5, |
| | | 1, |
| | | 1, |
| | | 1 |
| | α, β, γ, ζ | 0.8, |
| | | 0.5, |
| | | 0.5, |
| | | 0.7 |
| | P₁, P₂, P₃, P₄ | 0.5, |
| | | 0.5, |
| | | 0.5, |
| | | 0.5 |
| ISMC | A₁, A₂, A₃, A₄ | 3000, |
| | | 2000, |
| | | 1500, |
| | | 1500 |
| | m₁, m₂, m₃, m₄, m₅, m₆, | 5, |
| | m₇, m₈ | 1, |
| | | 1, |
| | | 1, |
| | | 2, |
| | | 1, |
| | | 1, |
| | | 1 |
| | α, β, γ, ζ | 0.8, |
| | | 0.5, |
| | | 0.5, |
| | | 0.7 |
| | P₁, P₂, P₃, P₄ | 0.5, |
| | | 0.5, |
| | | 0.5, |
| | | 0.5 |
| DISMC | A₁, A₂, A₃, A₄ | 3000, |
| | | 2000, |
| | | 1500, |
| | | 1500 |
| | m₁, m₂, m₃, m₄, m₅, m₆, | 5, |
| | m₇, m₈, m₉, m₁₀, m₁₁, m₁₂ | 1, |
| | | 1, |
| | | 2, |
| | | 0.5, |
| | | 1, |
| | | 2, |
| | | 1, |
| | | 1, |
| | | 1, |
| | | 2, |
| | | 1 |
| | α, β, γ, ζ | 0.8, |
| | | 0.5, |
| | | 0.5, |
| | | 0.7 |
| | P₁, P₂, P₃, P₄ | 0.5, |
| | | 0.5, |
| | | 0.5, |
| | | 0.5 |
| BFASMC | N̅ | 3000 |
| | φ₁, φ₂, φ₃, φ₄ | 10000, |
| | | 10000, |
| | | 20000, |
| | | 30000 |

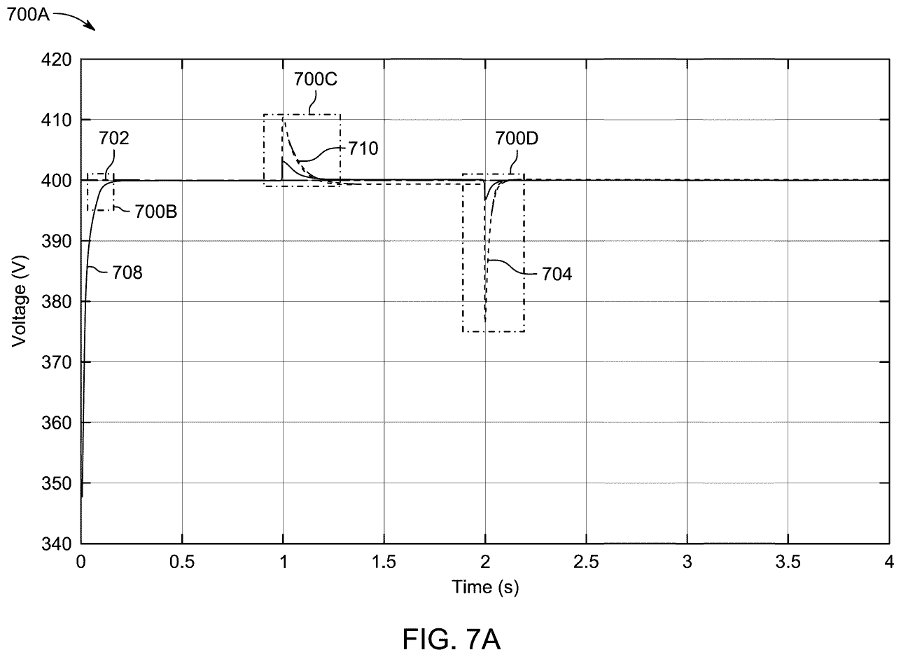

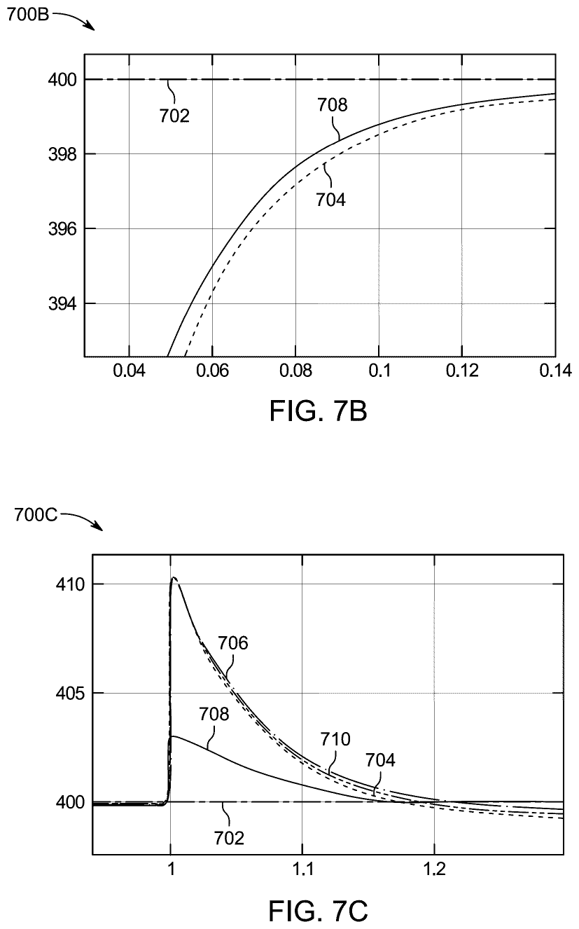

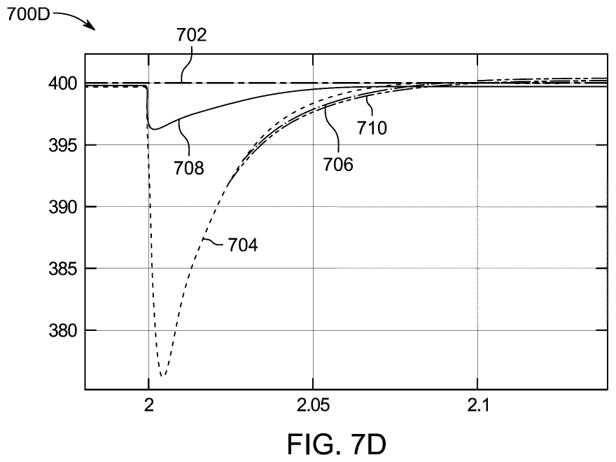

FIGS. 7A-7D illustrate exemplary graphical representations 700A-700D of direct current (DC) bus voltage, according to certain embodiments.

MATLAB/Simulink is used to examine the results of the proposed controller under varying loads. FIG. 7A shows the response of DC bus voltage for SMC, ISMC, DISMC, and BFASMC 202 with respect to the reference DC voltage. In FIGS. 7A-7D, a plot line 702 refers to reference DC voltage, a plot line 704 refers to DISMC DC voltage, a plot line 706 refers to SMC DC voltage, a plot line 708 refers to BFASMC DC voltage and a plot line 710 refers to ISMC DC voltage.

The DC bus voltage is tracked to the reference value (400V). The respective currents of each source are also regulated. The conventional controllers (e.g., SMC, ISMC, DISMC) and proposed controller (i.e., BFASMC) 202 track DC bus voltage accurately to the reference DC voltage value with permissible steady-state errors, undershoots, and overshoots. There is a sudden change in the load profile at t=1s and t=2s, due to which undershoot overshoot can be observed in the DC bus voltage response. The SMC has a steady state error of 0.19. the ISMC has the same performance, but the integral term has reduced its steady state error to 0.16. There are double integral terms in the DISMC, and therefore, the DISMC has a steady state error of 0.14. The proposed BFASMC 202 has reduced the state error to 0.04. The proposed BFASMC 202 also reduces the chattering effect enhanced by integral terms in ISMC and DISMC. The SMC has larger errors as compared to the other controllers (i.e., ISMC, DISMC, and BFASMC). The ISMC and DISMC have better results than the SMC, but the design is complex and involves oscillations. The BFASMC 202 has the best results, and the least errors, and assures global stability. A chattering effect also appears in the SMC, the ISMC, and the DISMC that is removed in the BFASMC 202 as elaborated in the zoomed area of FIGS. 7B-7C.

FIG. 7B shows section 700B of 700A where DC bus voltage of DISMC 704 and BFASMC 708 are depicted with respect to the reference voltage 702.

FIG. 7C shows section 700C of 700A where SMC DC voltage 706, ISMC DC voltage 710, DISMC DC voltage 704 and BFASMC DC voltage 708 suddenly increases (i.e., overshoots) at the t=1s and then follows the reference DC voltage 702. The BFASMC DC voltage 708 has lowest increased voltage as compared to SMC DC voltage 706, ISMC DC voltage 710 and DISMC DC voltage 704.

FIG. 7D shows section 700D of 700A SMC DC voltage 706, ISMC DC voltage 710, DISMC DC voltage 704 and BFASMC DC voltage 708 suddenly depreciates (i.e., undershoots) at the t=2s and then follows the reference DC voltage 702. The BFASMC DC voltage 708 has lowest decreased voltage as compared to SMC DC voltage 706, ISMC DC voltage 710 and DISMC DC voltage 704.

FIGS. 7A-7D show the BFASMC 202 has less deviations in DC voltage. This results in less chattering effects in the BFAMSC 202.

A comparison of peak values and steady-state errors of SMC, ISMC, DISMC, and BFASMC 202 shown in Table 4.

TABLE 4
COMPARISON OF CONTROLLERS

| Controller | Peak value | Steady-state error |
|---|---|---|
| SMC | 410.4 | 0.19 |
| ISMC | 410.3 | 0.16 |
| DISMC | 410.2 | 0.14 |
| BFASMC | 403 | 0.04 |

Based on the analysis of the steady-state errors, the BFASMC 202 is less sensitive to sudden disturbances and parameter uncertainties than the conventional controllers (e.g., SMC, ISMC, and DISMC) and hence the proposed controller (i.e., BFASMC) 202 has a lower steady-state error, peak value, convergence time, and rise time as compared to other conventional controllers.

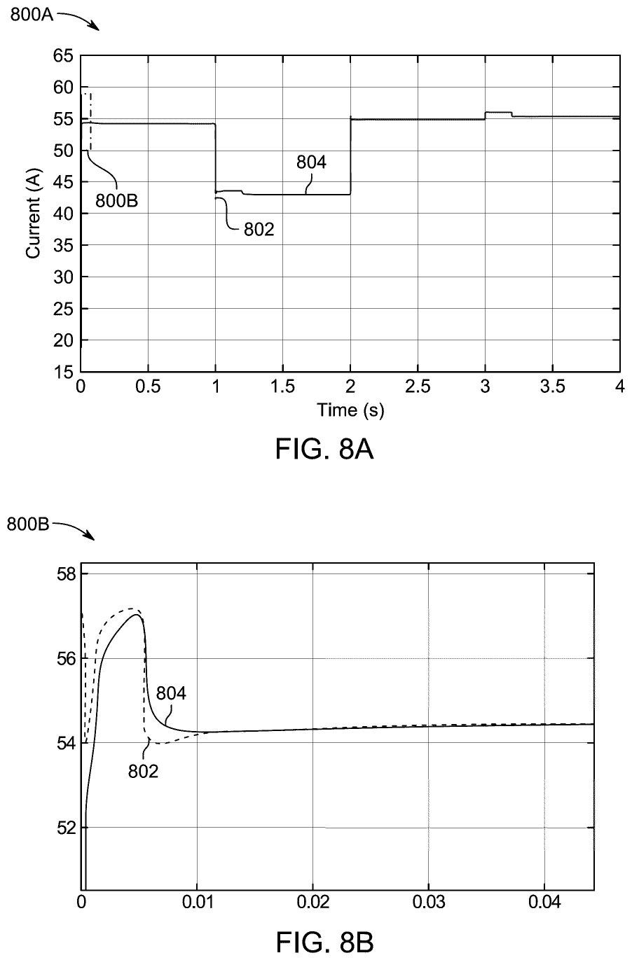

FIGS. 8A-8B illustrate exemplary graphical representations 800A, 800B of fuel cell current, according to certain embodiments.

As illustrated in FIGS. 8A-8B, fuel cell (FC) current 804 was tracked with their respective reference current value 802 for the proposed controller (i.e., BFASMC). The fuel cell current 804 follows the reference current value 802 as shown in FIGS. 8A-8B. FIG. 8B shows there is a slight deviation in fuel cell current 804 between the time t=0-0.1s with respect to the reference current value 802.

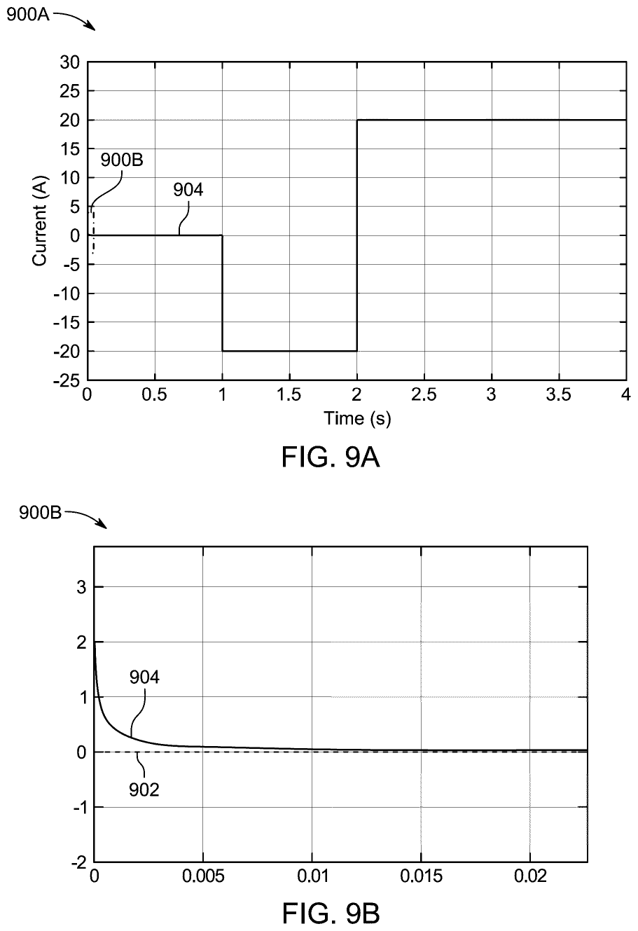

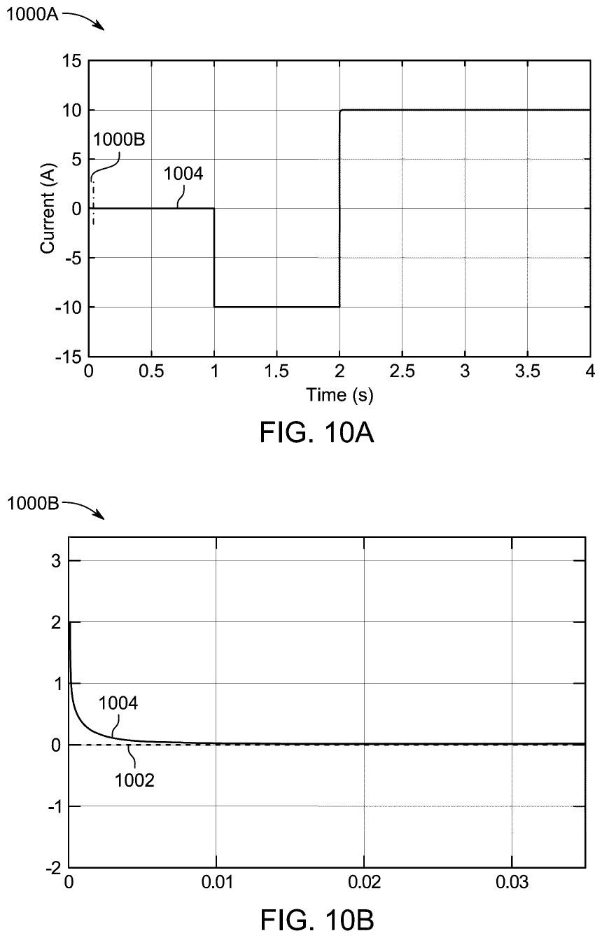

FIGS. 9A-9B illustrate exemplary graphical representations 900A, 900B of battery current, according to certain embodiments.

As illustrated in FIGS. 9A-9B, battery current 904 was tracked with their respective reference current value 902 for the proposed controller (i.e., BFASMC). The battery current 904 follows the reference current value 902 as shown in FIGS. 9A-9B. FIG. 9B shows there is slight deviation in battery current 904 between the time t 0-0.005s with respect to the reference current value 902.

FIGS. 10A-10B illustrate exemplary graphical representations 1000A, 1000B of supercapacitor current, according to certain embodiments.

As illustrated in FIGS. 10A-10B, the supercapacitor current 1004 was tracked with their respective reference current value 1002 for the proposed controller (i.e., BFASMC). The supercapacitor current 1004 follows the reference current value 1002 as shown in FIGS. 10A-10B. FIG. 10B shows there is slight deviation in the supercapacitor current 1004 between the time t 0-0.1s with respect to the reference current value 1002.

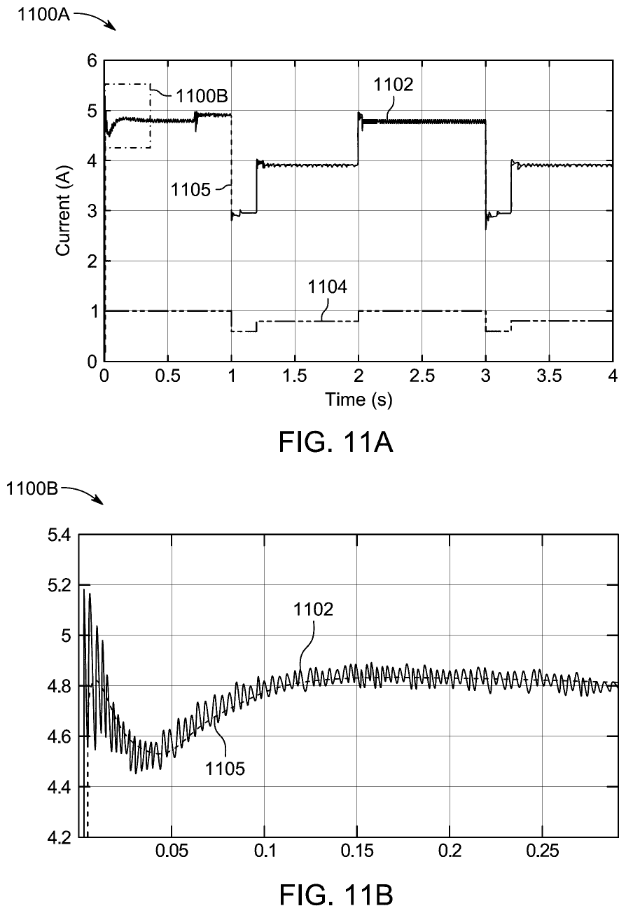

FIGS. 11A-11B illustrate exemplary graphical representations 1100A, 1100B of photovoltaic (PV) panel currents, according to certain embodiments.

As illustrated in FIGS. 11A-11B, the PV panel current 1105 was tracked with their respective reference current value 1102 for the proposed controller (i.e., BFASMC) and solar irradiance 1104. The PV panel current 1105 appears above the solar irradiance (i.e., appears at 0-1A). The PV panel current 1105 follows the reference current value 1102 as shown in FIGS. 11A-11B. FIG. 11B shows there is slight deviation in PV panel current 1105 between the time t 0-0.25s with respect to the reference current value 1102.

The tracking of fuel cell current, battery current, supercapacitor current and PV panel current for the proposed controller (i.e., BFASMC) shows that the BFASMC has less deviations with respect to the reference current. This tracking is robust, fast, and accurate.

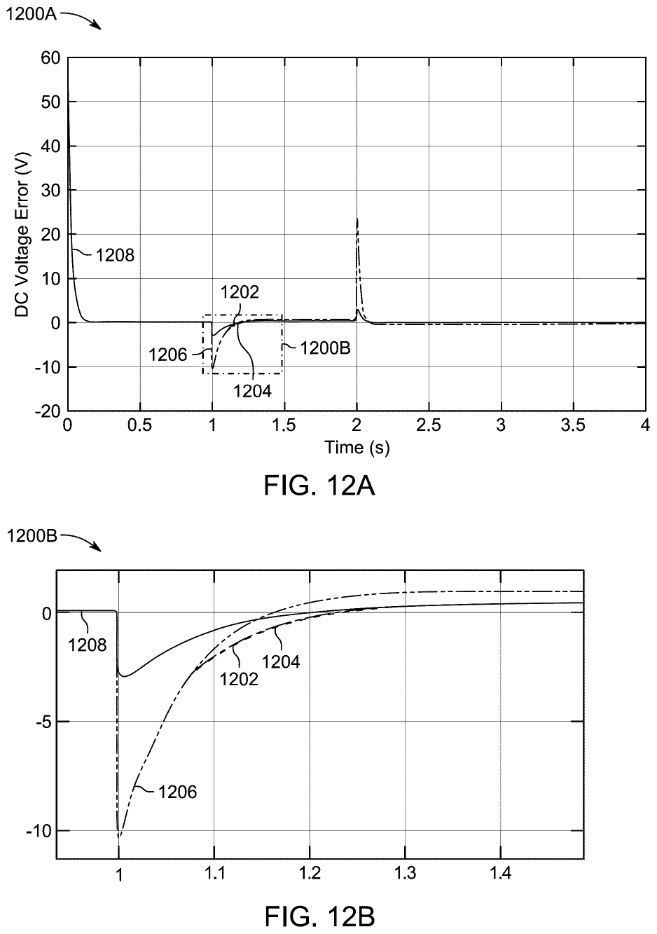

FIGS. 12A-12B illustrate exemplary graphical representations 1200A, 1200B of DC bus voltage error, according to certain embodiments. FIGS. 12A-12B include SMC 1202, ISMC 1204, DISMC 1206 and BFASMC 1208.

As illustrated in FIG. 12A, the error in DC bus voltage is almost zero except where there are some fluctuations in load current i.e., t=1s and t=2s. FIG. 12B shows fluctuations in the DC bus voltage at t=1s.

Further, a comparison of the error in DC bus voltage (shown in FIG. 12A) while tracking the DC voltage to its reference value (400V) in the case of the DISMC and the proposed controller BFASMC 202. The comparison demonstrates that the DC bus voltage of the BFASMC 202 has the least error and, therefore, highlights the superiority of the BFASMC 202.

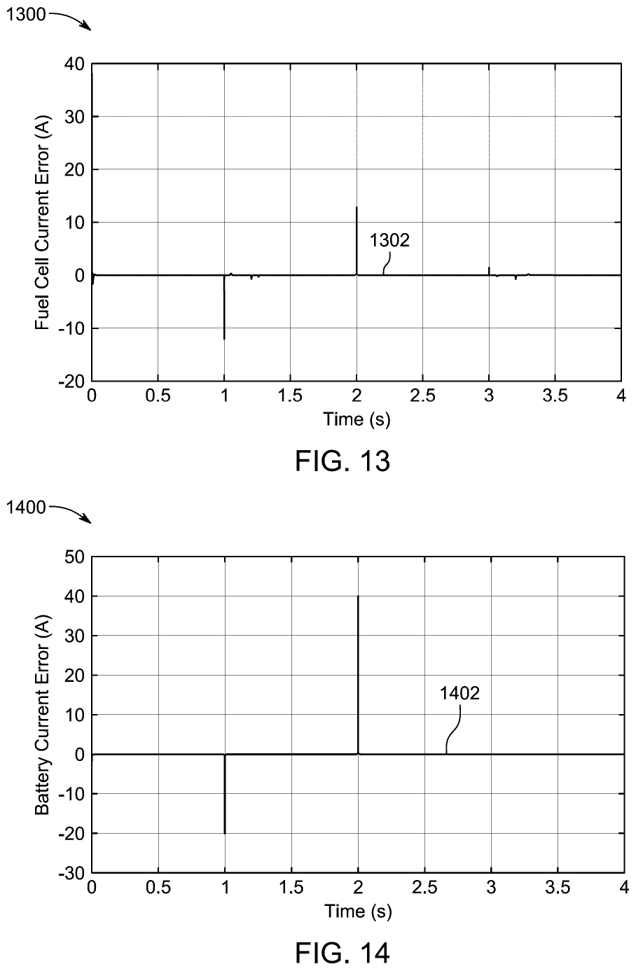

FIG. 13 illustrates an exemplary graphical representation 1300 of fuel cell current error, according to certain embodiments.

As illustrated in FIG. 13, fuel cell (FC) current error 1302 was tracked for the proposed controller (i.e., BFASMC). The fuel cell current error 1302 is almost zero, as shown in FIG. 13, but there is a spike in fuel cell current error 1302 at time t=1s and 2s.

FIG. 14 illustrates exemplary graphical representation 1400 of battery current error, according to certain embodiments.

As illustrated in FIG. 14, battery current error 1402 was tracked for the proposed controller (i.e., BFASMC). The battery current error 1402 is almost zero as shown in FIG. 14, but there is spike in battery current error 1402 at time t=1s and 2s.

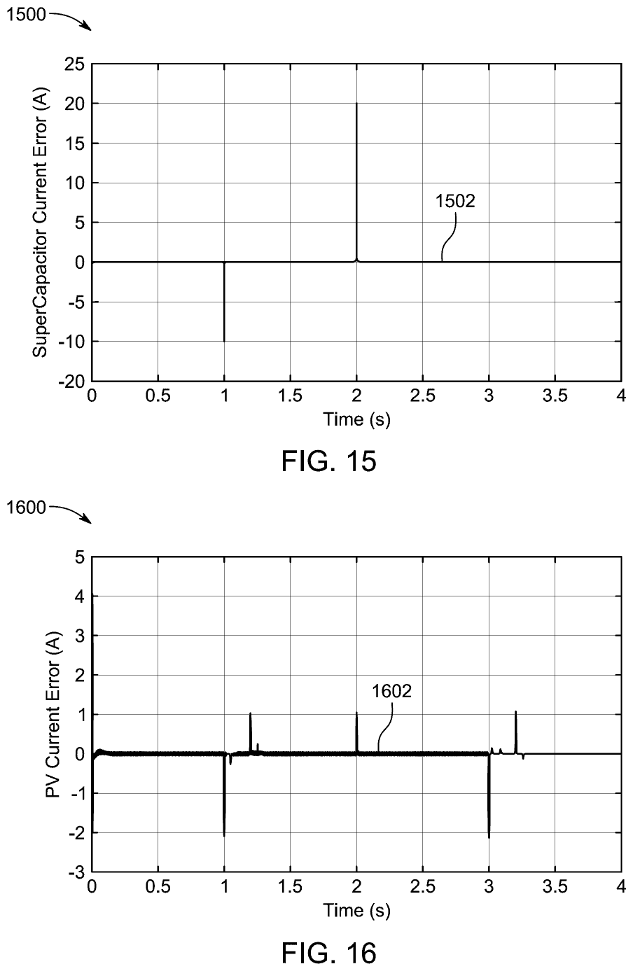

FIG. 15 illustrates an exemplary graphical representation 1500 of supercapacitor current error, according to certain embodiments.

As illustrated in FIG. 15, supercapacitor current error 1502 was tracked for the proposed controller (i.e., BFASMC). The supercapacitor current error 1502 is almost zero as shown in FIG. 15, but there is spike in supercapacitor current error 1502 at time t=1s and 2s.

FIG. 16 illustrates an exemplary graphical representation 1600 of PV panel current error, according to certain embodiments.

As illustrated in FIG. 16, the PV panel current error 1602 was tracked for the proposed controller (i.e., BFASMC). The PV panel current error 1602 is almost zero as shown in FIG. 16, but there is spike in PV panel current error 1602 at time t=1s, 2s and 3s.

Errors in currents of the plurality of energy resources (i.e., FC, battery, SC, and PV panel) 102 are shown in FIGS. 13-16. The error in all currents ((i.e., FC, battery, SC, and PV panel currents)) is almost zero except where there are some fluctuations in load current, i.e., t=1s and t=2s.

Table 5 presents a comparative assessment of the proposed controller with conventional SMC variants. The BFASMC 202 has superior features compared to conventional controllers SMC, ISMC, and DISMC, respectively.

TABLE 5
COMPARATIVE ASSESSMENT OF PROPOSED
CONTROLLER WITH CONVENTIONAL SMC
VARIANTS

| SMC | ISMC | DISMC | BFASMC |
|---|---|---|---|
| Robust | More | Less robust | Highly |
| performance | robust as | to external | robust to |
| under changing | compared | disturbances | external |
| parameters and | to SMC. | and uncer- | disturbances |
| disturbances. | | tainties as | and |
| | | compared to | uncertainties. |
| | | BFASMC. | |
| Experience | Can handle | More efficient | Easily adapts |
| chattering. | uncertainties | than ISMC but | to changes |
| | moreefficient- | still works | in system |
| | ly than SMC. | for fixed system | dynamics and |
| | | parameters. | uncertainties. |
| System may | More stable | Stable but may | Barrier function |
| not be stable | than SMC as | include chatter- | ensures the |
| in some cases. | it involves | ing for some | stability of the |
| | integral term. | systems. | controller. |
| Simple to | Simple to | More efficient | Provides better |
| implement | implement | than ISMC | safety by |
| and design. | but requires | but still do not | ensuring the |
| | accurate | ensure safety | system operates |
| | estimation | without addi- | within feasible |
| | of integral | tional | regions, pre- |
| | term. | constraints. | venting unsafe |
| | | | conditions. |
| Poor | Better steady | May not | Good |
| transient | state | perform well | performance |
| response. | performance. | for highly | even for |
| | | dynamic | complex |
| | | environment. | systems. |

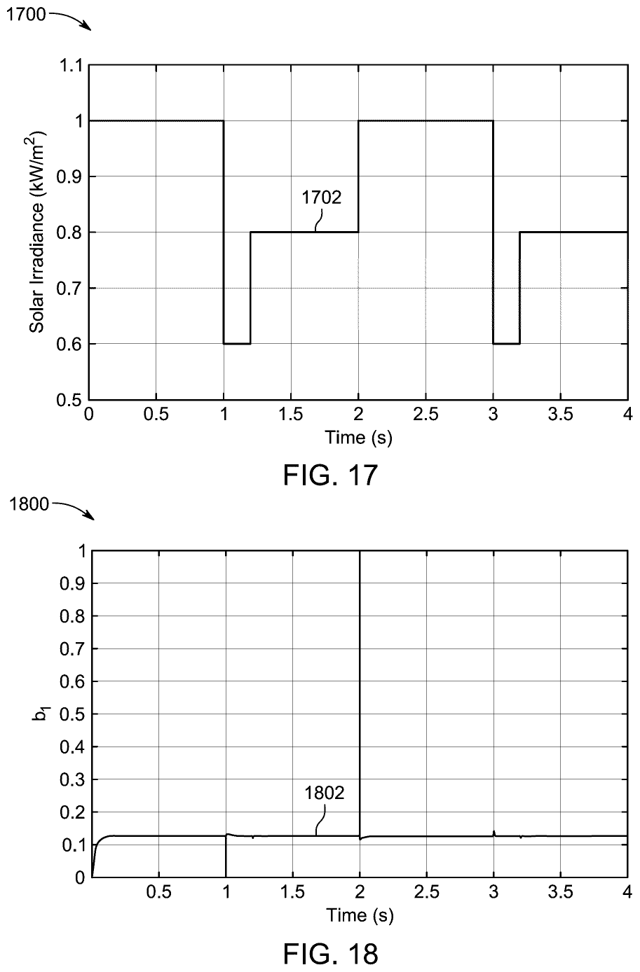

FIG. 17 illustrates an exemplary graphical representation 1700 of solar irradiance variation on the PV panel 102-4, according to certain embodiments.

Solar irradiance is the amount of sunlight energy that falls on a given surface area, typically measured in watts per square meter (W/m²). When the PV panel 102-4 receives more sunlight (higher irradiance), it generates more electricity, as sunlight energy is converted into electrical energy through the photovoltaic effect. However, both temperature and solar irradiance affect the power generated by the PV panel 102-4. As the temperature of the PV panel 102-4 increases, its ability to convert sunlight into electricity diminishes due to increased resistance within the materials of the PV panel 102-4 as they heat up. While higher irradiance leads to more power generation, higher temperatures decrease the efficiency of that power generation. To analyze the solar irradiance of the PV panel 102-4, real solar irradiance and temperature profiles are used for the simulation of the PV panel 102-4. The plot of the solar irradiance on PV panel is shown in FIG. 17 as 1702.

FIG. 18 illustrates exemplary graphical representation 1800 of pulse width modulation (PWM) duty ratio of control input (b₁), according to certain embodiments.

The control inputs b₁, b₂₃, b₄₅, and be presented in FIGS. 18-22 are PWM duty ratios. The control inputs b₁, b₂₃, b₄₅, and b₆ have values between 0 and 1.

In an aspect, the duty ratio (also referred to as duty cycle) is a measure of the fraction of time the IGBT is on during one cycle. The duty ratios help in controlling the output of the converters by turning the IGBT switches ON and OFF as required.

As illustrated in FIG. 18, the PWM duty ratio of control input (b₁) 1802 was tracked for the proposed controller (i.e., BFASMC). The PWM duty ratio of control input (b₁) is almost constant as shown in FIG. 18, but there is spike in the PWM duty ratio of control input (b₁) at time t=1s and 2s.

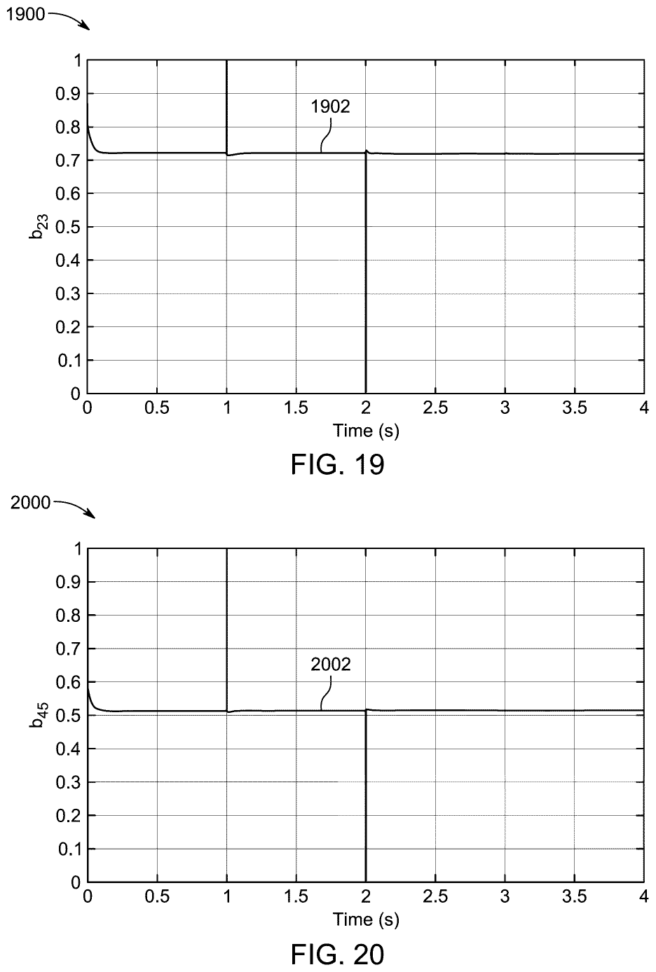

FIG. 19 illustrates an exemplary graphical representation 1900 of PWM duty ratio of control input (b₂₃), according to certain embodiments.

As illustrated in FIG. 19, the PWM duty ratio of control input (b₂₃) 1902 was tracked for the proposed controller (i.e., BFASMC). The PWM duty ratio of control input (b₂₃) is almost constant as shown in FIG. 19, but there is spike in the PWM duty ratio of control input (b₂₃) at time t=1s and 2s.

FIG. 20 illustrates an exemplary graphical representation 2000 of PWM duty ratio of control input (b₄₅), according to certain embodiments.

As illustrated in FIG. 20, the PWM duty ratio of control input (b₄₅) 2002 was tracked for the proposed controller (i.e., BFASMC). The PWM duty ratio of control input (b₄₅) is almost constant as shown in FIG. 20, but there is spike in the PWM duty ratio of control input (b₄₅) at time t=1s and 2s.

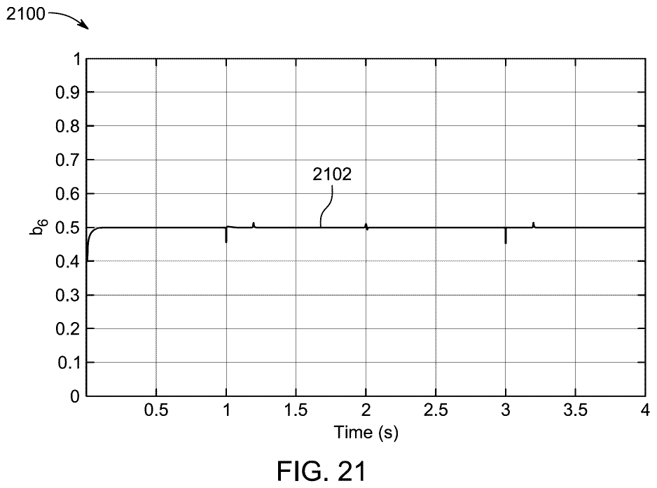

FIG. 21 illustrates an exemplary graphical representation 2100 of PWM duty ratio of control input (b₆), according to certain embodiments.

As illustrated in FIG. 21, the PWM duty ratio of control input (b₆) 2102 was tracked for the proposed controller (i.e., BFASMC). The PWM duty ratio of control input (b₆) is almost constant as shown in FIG. 21, but there is spike in the PWM duty ratio of control input (b₆) at time t=1s and 2s.

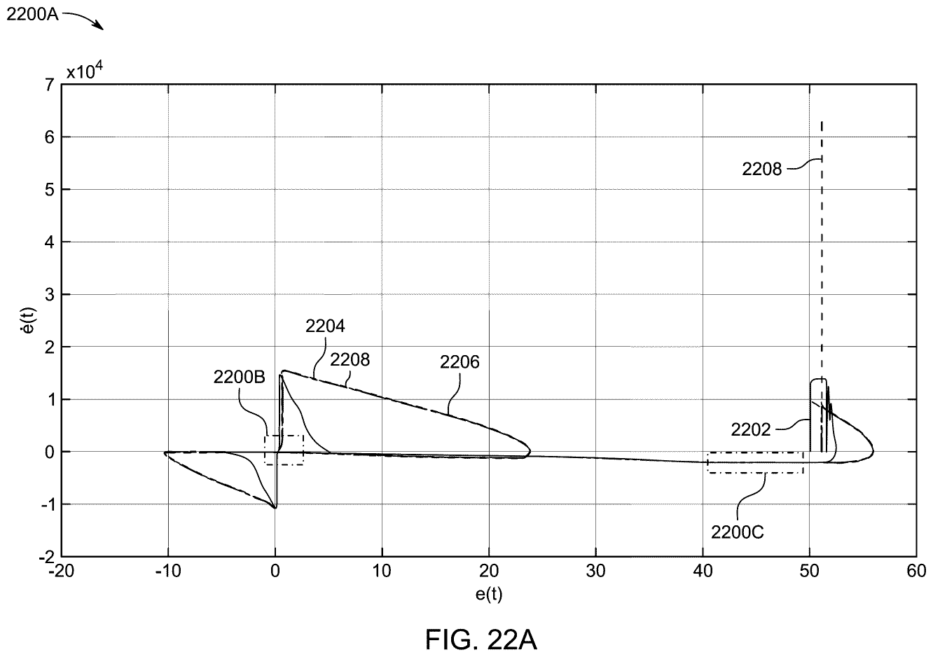

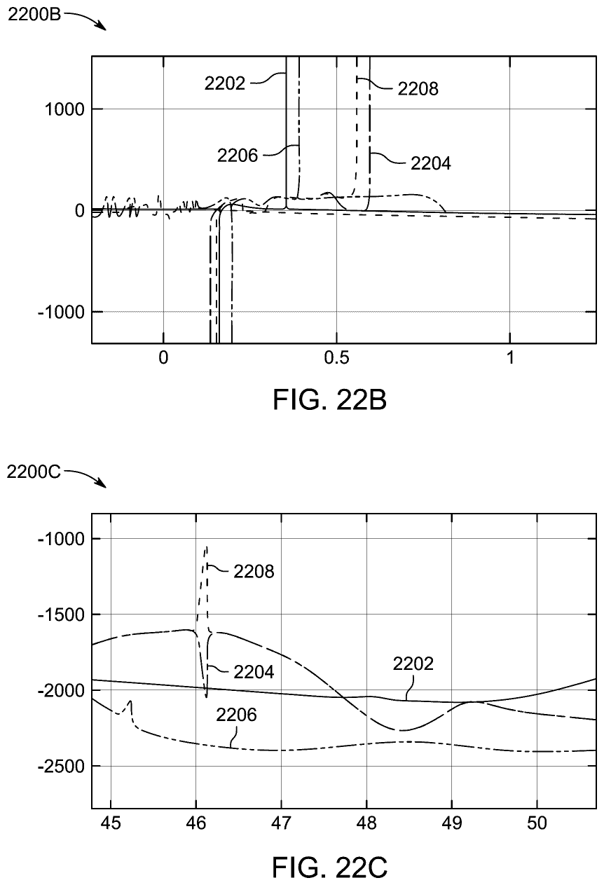

FIGS. 22A-22C illustrate exemplary graphical representations 2200A, 2200B, 2200C of comparison of a SMC phase plane 2208, a ISMC phase plane 2206, a DISMC phase plane 2204, and a BFASMC plane 2202, according to certain embodiments.

As illustrated in FIGS. 22A-22C, comparisons of the phase plane (e.g., error e(t) and error differential ė(t)) of the proposed controller 202 and the conventional controllers. FIG. 22B shows sudden spike between error 0-1. FIG. 22C shows spikes between error 46-50.

As illustrated in FIGS. 22A-22C, the SMC shows significant initial spikes and a longer time to stabilize. The ISMC converges faster than the SMC with a good response. The DISMC follows a more direct trajectory with less overshoot and better response than the SMC. The BFASMC 202 gives the best response with a smooth path to the origin, minimal chattering, and ensure fast stability.

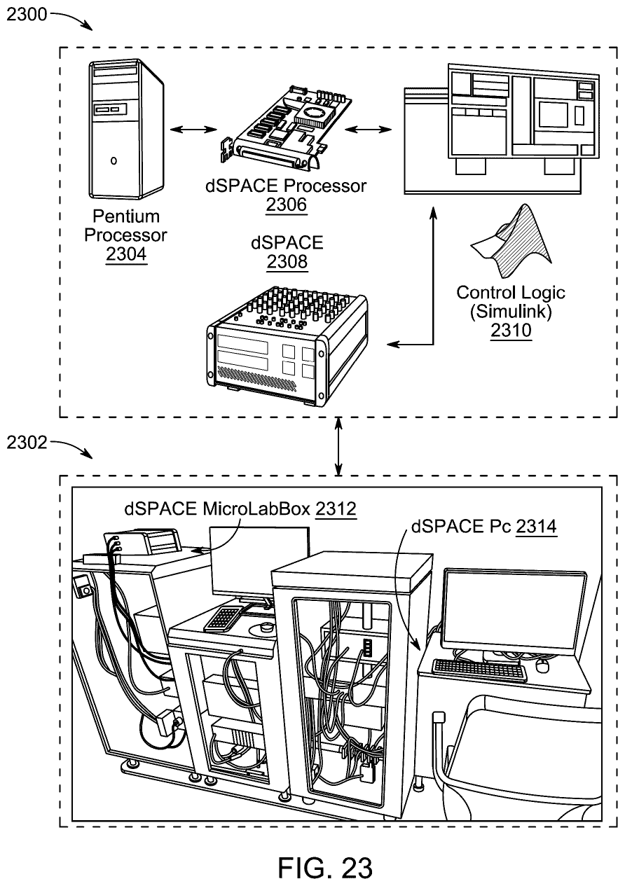

FIG. 23 illustrates an exemplary experimental setup 2300, according to certain embodiments.

As illustrated in FIG. 23, the experimental setup 2300 comprises a pentinum processor 2304, a dSPACE processor 2306, a platform (e.g., the dSPACE RTI1202 platform) 2308, and a control logic 2310. An actual lab setup 2302 comprises a dSPACE MicroLab box 2312 and a dSPACE PC 2314. The dSPACE RTI1202 platform is used for real-time analysis of the proposed controller 202. It also shows the setup of the hardware implementation. A hardware-in-the loop (HIL) configuration with the control logic (MATLAB/Simulink) 2310 is executed in real-time on the dSPACE PC 2314. The dSPACE processor 2306 and hardware of the dSPACE PC 2314 allow real-time testing, while the Pentium CPU 2304 handles initial simulations. The controller was developed on the dSPACE RTI1202 2308 to balance real-time requirements with system behavior using an automated solver selection with a fixed-step size of 0.2 milliseconds. The process of generating code was carried out using Simulink's Embedded Coder. The generated executable was then deployed to the RTI1202 2308. The dSPACE PC 2314 (also known as dSPACE Control Desk) controlled real-time execution, monitoring, and data assembling.

The MATLAB/Simulink 2310 has been used to evaluate the performance of the proposed controller (i.e., BFASMC) 202 under varying load conditions and disturbances. The hardware validation on the dSPACE platform 2308 verifies the viability and efficacy of the proposed controller using real-time analysis.

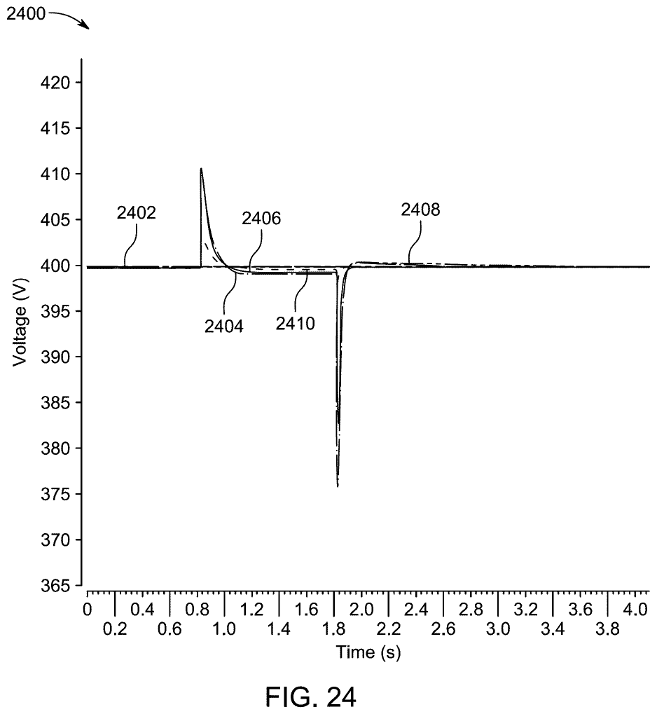

FIG. 24 illustrates an exemplary graphical representation 2400 of DC bus voltage (dSPACE), according to certain embodiments.

As illustrated in FIG. 24, a comparison of the SMC DC bus voltage 2404, the ISMC DC bus voltage 2406, the DISMC DC bus voltage 2408, and the BFASMC DC bus voltage 2410 against reference DC bus voltage 2402. According to real-time analysis, DC bus voltage values of the SMC, the ISMC, and the DISMC were at 399.823 V, 399.838 V, and 399.869 V. The BFASMC 202 has a DC bus voltage of 399.958 V which indicates that the BFASMC 202 has the least steady-state error. Therefore, real-time analysis using the dSPACE has also proven that tracking of DC bus voltage using the BFASMC 202 gives better results than the SMC, the ISMC, and the DISMC.

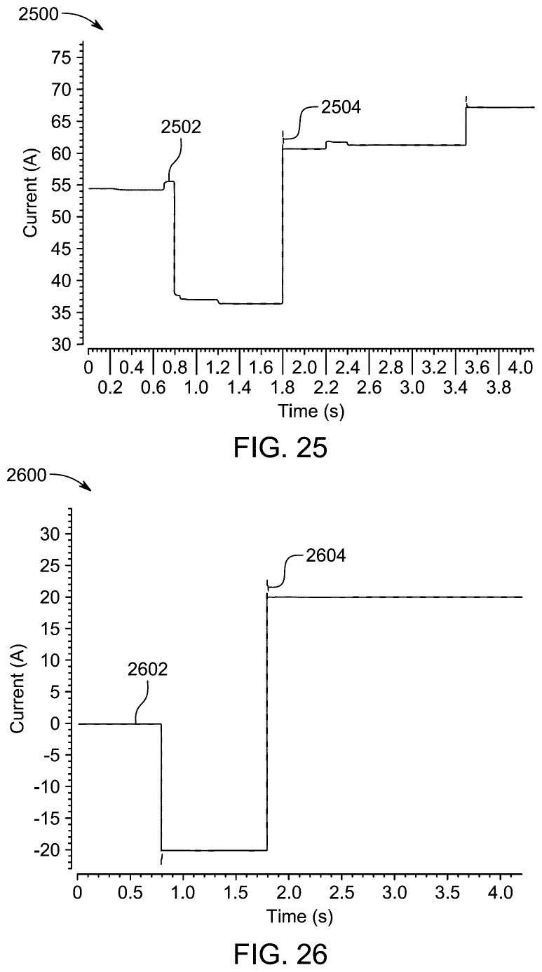

FIG. 25 illustrates an exemplary graphical representation 2500 of fuel cell current (dSPACE), according to certain embodiments.

As illustrated in FIG. 25, fuel cell current 2504 was tracked with their respective reference current value 2502 for the proposed controller (i.e., BFASMC). The fuel cell current 2504 follows the reference current value 2502. FIG. 25 shows there is slight deviation in fuel cell current 2504 at time t=1.8 and 3.5 with respect to the reference current value 2502.

FIG. 26 illustrates an exemplary graphical representation 2600 of battery current (dSPACE), according to certain embodiments.

As illustrated in FIG. 26, battery current 2604 was tracked with their respective reference current value 2602 for the proposed controller (i.e., BFASMC). The battery current 2604 follows the reference current value 2602. FIG. 26 shows there is slight deviation in battery current 2604 at time t=0.8 and 1.8 with respect to the reference current value 2602.

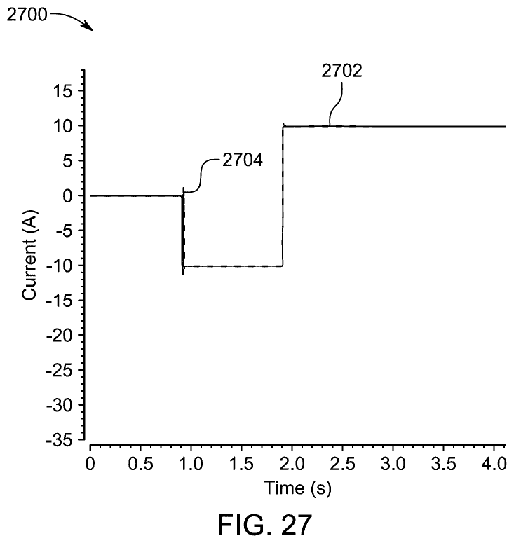

FIG. 27 illustrates an exemplary graphical representation 2700 of supercapacitor current (dSPACE), according to certain embodiments.

As illustrated in FIG. 27, the supercapacitor current 2704 was tracked with their respective reference current value 2702 for the proposed controller (i.e., BFASMC). The supercapacitor current 2704 follows the reference current value 2702. FIG. 27 shows there is slight deviation in the supercapacitor current 2704 at time t=1 with respect to the reference current value 2702.

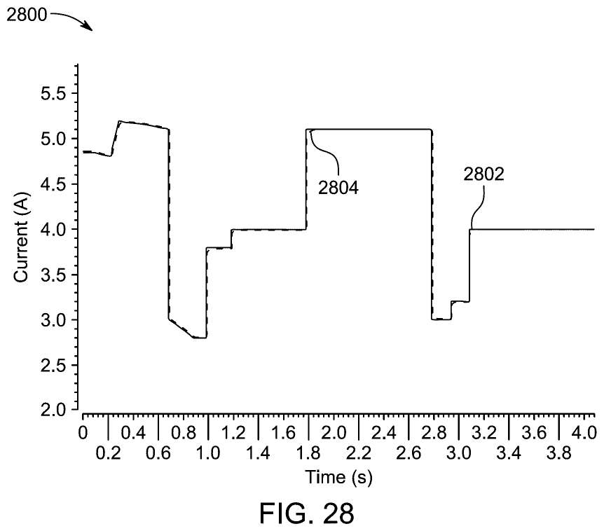

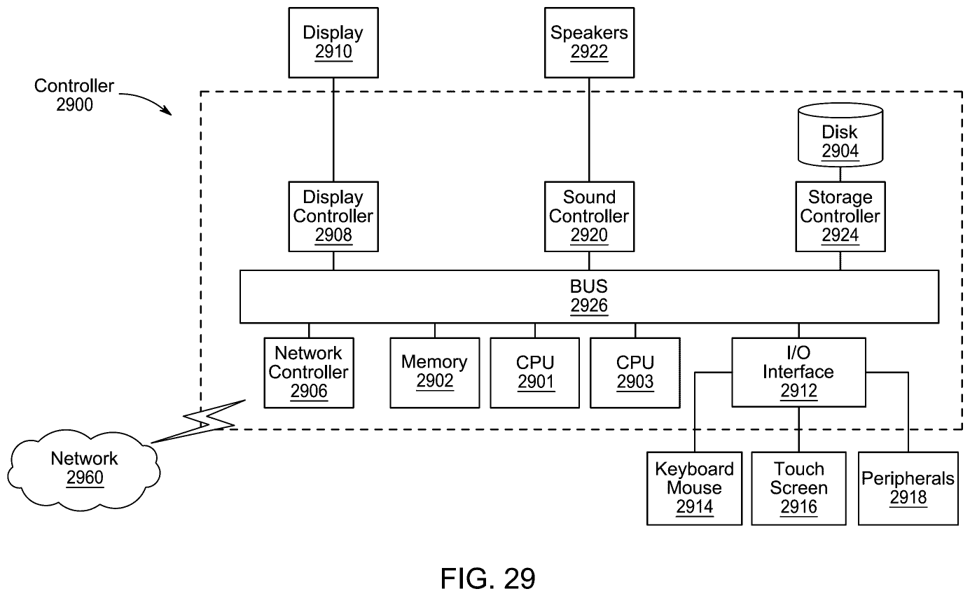

FIG. 28 illustrates an exemplary graphical representation 2800 of PV panel current (dSPACE), according to certain embodiments.

As illustrated in FIG. 28, the PV panel current 2804 was tracked with their respective reference current value 2802 for the proposed controller (i.e., BFASMC). The PV panel current 2804 follows the reference current value 2802.

As illustrated in FIGS. 25-28, the tracking of currents (dSPACE) of the plurality of energy sources (e.g., FC, battery, SC, and PV panel) 102 is shown. The BFASMC 202 has reduced the chattering effect and steady-state error and has faster convergence. The DISMC has a larger steady-state error, chattering effect, and complexities as it involves integral terms. The BFASMC 202 is, therefore, a robust controller that is less sensitive to changes in control input and easily adjusts its output as required during a transient state. The BFASMC 202 suppresses any disturbance in a control signal and minimizes the steady-state error.

In an aspect, the BFASMC 202 overcomes the limitations of conventional controllers and provides superior results by eliminating both the chattering effect and steady-state error. Based on the results, the BFASMC 202 proves to be more robust and performs better than the other controllers, as it avoids overestimation, which helps minimize the chattering effect.

First embodiment is illustrated with respect to FIGS. 1-3. The first embodiment describes a multisource hybrid energy storage system 100 used in an electric vehicle. The multisource hybrid energy storage system 100 comprises a plurality of energy sources 102, a plurality of DC-DC converters 104, a DC bus 106, a DC-AC inverter 108, and a sliding mode controller 202. The plurality of energy sources 102 include a fuel cell 102-1, a battery 102-2, a supercapacitor 102-3, and a PV panel 102-4. The plurality of DC-DC converters 104 include a first DC-DC boost converter 104-1, a second DC-DC buck-boost converter 104-2, a third DC-DC buck-boost converter 104-3, and a fourth DC-DC boost converter 104-4. An input of the first DC-DC boost converter 104-1 is coupled to the FC 102-1, and an output of the first DC-DC boost converter 104-1 is coupled to the DC bus 106. An input of the second DC-DC buck-boost converter 104-2 is coupled to the battery 102-2, and an output of the second DC-DC buck-boost converter 104-2 is coupled to the DC bus 106. An input of the third DC-DC buck-boost converter 104-3 is coupled to the supercapacitor 102-3, and an output of the third DC-DC buck-boost converter 104-3 is coupled to the DC bus 106. An input of the fourth DC-DC boost converter 104-4 is coupled to the PV panel 102-4, and an output of the fourth DC-DC boost converter 104-4 is coupled to the DC bus 106. The DC-AC inverter 108 inverts DC electric power from the DC bus 106 into AC electric power and supplies the AC electric power to a motor 110 of the electric vehicle 200. The sliding mode controller 202 controls operation of the multisource hybrid energy storage system 100 by applying a barrier-function-based controller gain to regulate a DC voltage at the DC bus 106 to a reference voltage.

In an aspect, the sliding mode controller 202 switches a controller gain between a constant value and an adaptive barrier-function-based gain.

In an aspect, the sliding mode controller 202 monitors a derivative of a barrier function and adjusts a control parameter based on the monitored derivative.

In an aspect, the barrier-function-based controller gain is applied based on a positive-definite barrier function (PBF) or a positive semi-definite barrier function (PSBF).

In an aspect, the first DC-DC boost converter 104-1 is a DC-DC boost converter, including a resistor, an inductor, a capacitor, an insulated gate bipolar transistor (IGBT) switch, and a diode.

In an aspect, the second DC-DC buck-boost converter 104-2 is a DC-DC buck-boost converter, including a resistor, an inductor, two IGBT or Metal-Oxide-Semiconductor Field Effect Transistor (MOSFET) switches, and two diodes.

In an aspect, the third DC-DC buck-boost converter 104-3 is a DC-DC buck-boost converter, including a resistor, an inductor, two IGBT switches, and two diodes.

In an aspect, the fourth DC-DC boost converter 104-4 is a DC-DC boost converter, including a resistor, an inductor, a capacitor, an IGBT switch, and a diode.

In an aspect, the PV panel 102-4 includes a plurality of photovoltaic panels arranged in strings.

In an aspect, the reference voltage is 400 V.

Second embodiment is illustrated with FIGS. 1-3. The second embodiment describes an electric vehicle 200 comprises a motor 110 and a multisource hybrid energy storage system 100 for powering the motor 110 is described. The multisource hybrid energy storage system 100 includes a plurality of energy sources 102, a plurality of DC-DC converters 104, a DC bus 106, a DC-AC inverter 108, and a sliding mode controller 202. The plurality of energy sources 102 include a fuel cell 102-1, a battery 102-2, a supercapacitor 102-3, and a PV panel 102-4. The plurality of DC-DC converters 104 include a first DC-DC boost converter 104-1, a second DC-DC buck-boost converter 104-2, a third DC-DC buck-boost converter 104-3, and a fourth DC-DC boost converter 104-4. An input of the first DC-DC boost converter 104-1 is coupled to the FC 102-1, and an output of the first DC-DC boost converter 104-1 is coupled to the DC bus 106. An input of the second DC-DC buck-boost converter 104-2 is coupled to the battery 102-2, and an output of the second DC-DC buck-boost converter 104-2 is coupled to the DC bus 106. An input of the third DC-DC buck-boost converter 104-3 is coupled to the supercapacitor 102-3, and an output of the third DC-DC buck-boost converter 104-3 is coupled to the DC bus 106. An input of the fourth DC-DC boost converter 104-4 is coupled to the PV panel 102-4, and an output of the fourth DC-DC boost converter 104-4 is coupled to the DC bus 106. The DC-AC inverter 108 inverts DC electric power from the DC bus 106 into AC electric power and supplies the AC electric power to the motor 110. The controller is a sliding mode controller 202 configured to apply a barrier-function-based controller gain to regulate a DC voltage at the DC bus 106 to a reference voltage.

In an aspect, the sliding mode controller 202 switches a controller gain between a constant value and an adaptive barrier-function-based gain.

In an aspect, the sliding mode controller 202 monitors a derivative of a barrier function, and adjusts a control parameter based on the monitored derivative.

In an aspect, the barrier-function-based controller gain is applied based on a positive-definite barrier function (PBF) or a positive semi-definite barrier function (PSBF).

In an aspect, the first DC-DC boost converter 104-1 is a DC-DC boost converter, including a resistor, an inductor, a capacitor, an IGBT switch, and a diode.

In an aspect, the second DC-DC buck-boost converter 104-2 is a DC-DC buck-boost converter, including a resistor, an inductor, two IGBT or MOSFET switches, and two diodes.

In an aspect, the third DC-DC buck-boost converter 104-3 is a DC-DC buck-boost converter, including a resistor, an inductor, two IGBT switches, and two diodes.

In an aspect, the fourth DC-DC boost converter 104-4 is a DC-DC boost converter, including a resistor, an inductor, a capacitor, an IGBT switch, and a diode.

In an aspect, the reference voltage is 400 V.

FIG. 29 illustrates a non-limiting example of details of computing hardware, according to certain embodiments, for performing the functions of the exemplary embodiments.

In FIG. 29, a controller 2900 is described is representative of the multisource hybrid energy storage system 102 of FIG. 1 in which the controller is a computing device which includes a CPU 2901 which performs the processes described above/below. The process data and instructions may be stored in memory 2902. These processes and instructions may also be stored on a storage medium disk 2904 such as a hard drive (HDD) or portable storage medium or may be stored remotely.

Further, the present disclosure is not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the present disclosure may be provided as a utility application, background daemon, or component of an operating system, or combination thereof, executing in conjunction with CPU 2901, 2903 and an operating system such as Microsoft Windows 7, Microsoft Windows 10, UNIX, LINUX, Apple MAC-OS and other systems known to those skilled in the art.

The hardware elements in order to achieve the computing device may be realized by various circuitry elements, known to those skilled in the art. For example, CPU 2901 or CPU 2903 may be a Xenon or Core processor from Intel of America or an Opteron processor from AMD of America, or may be other processor types that would be recognized by one of ordinary skill in the art. Alternatively, the CPU 2901, 2903 may be implemented on an FPGA, ASIC, PLD or using discrete logic circuits, as one of ordinary skill in the art would recognize. Further, CPU 2901, 2903 may be implemented as multiple processors cooperatively working in parallel to perform the instructions of the inventive processes described above.

The computing device in FIG. 29 also includes a network controller 2906, such as an Intel Ethernet PRO network interface card from Intel Corporation of America, for interfacing with network 2960. As can be appreciated, the network 2960 can be a public network, such as the Internet, or a private network such as an LAN or WAN network, or any combination thereof and can also include PSTN or ISDN sub-networks. The network 2960 can also be wired, such as an Ethernet network, or can be wireless such as a cellular network including EDGE, 3G, 4G, and 5G wireless cellular systems. The wireless network can also be WiFi, Bluetooth, or any other wireless form of communication that is known.

The computing device further includes a display controller 2908, such as a NVIDIA GeForce GTX or Quadro graphics adaptor from NVIDIA Corporation of America for interfacing with display 2910, such as a Hewlett Packard HPL2445w LCD monitor. A general purpose I/O interface 2912 interfaces with a keyboard and/or mouse 2914 as well as a touch screen panel 2916 on or separate from display 2910. General purpose I/O interface also connects to a variety of peripherals 2918 including printers and scanners, such as an OfficeJet or DeskJet from Hewlett Packard.

A sound controller 2920 is also provided in the computing device such as Sound Blaster X-Fi Titanium from Creative, to interface with speakers/microphone 2922 thereby providing sounds and/or music.

The general-purpose storage controller 2924 connects the storage medium disk 2904 with communication bus 2926, which may be an ISA, EISA, VESA, PCI, or similar, for interconnecting all of the components of the computing device. A description of the general features and functionality of the display 2910, keyboard and/or mouse 2914, as well as the display controller 2908, storage controller 2924, network controller 2906, sound controller 2920, and general purpose I/O interface 2912 is omitted herein for brevity as these features are known.

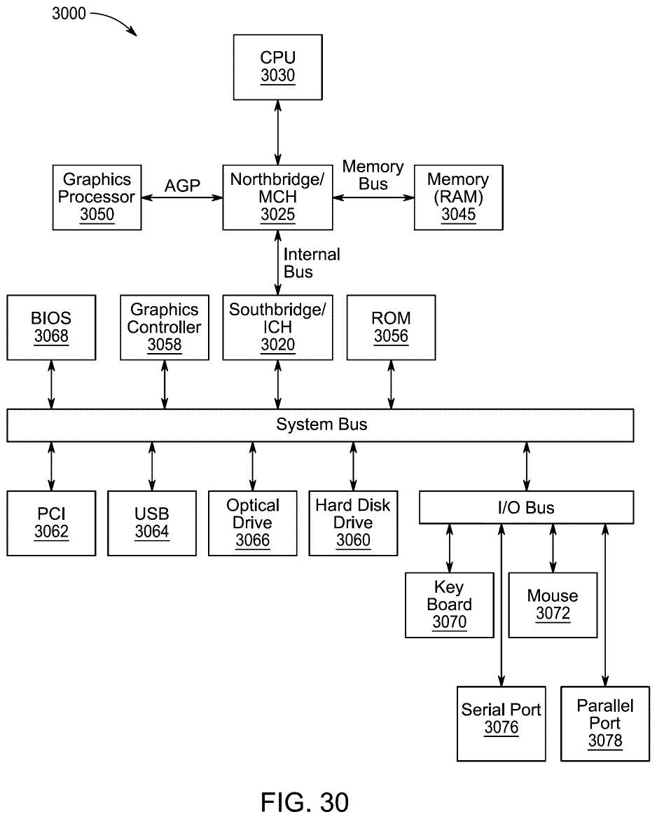

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as illustrated in FIG. 30.

FIG. 30 illustrates a schematic diagram of a data processing system, according to certain embodiments, for performing the functions of the exemplary embodiments. The data processing system is an example of a computer in which code or instructions implementing the processes of the illustrative embodiments may be located.

In FIG. 30, data processing system 3000 employs a hub architecture including a north bridge and memory controller hub (NB/MCH) 3025 and a south bridge and input/output (I/O) controller hub (SB/ICH) 3020. The central processing unit (CPU) 3030 is connected to NB/MCH 3025. The NB/MCH 3025 also connects to the memory 3045 via a memory bus, and connects to the graphics processor 3050 via an accelerated graphics port (AGP). The NB/MCH 3025 also connects to the SB/ICH 3020 via an internal bus (e.g., a unified media interface or a direct media interface). The CPU Processing unit 3030 may contain one or more processors and even may be implemented using one or more heterogeneous processor systems.

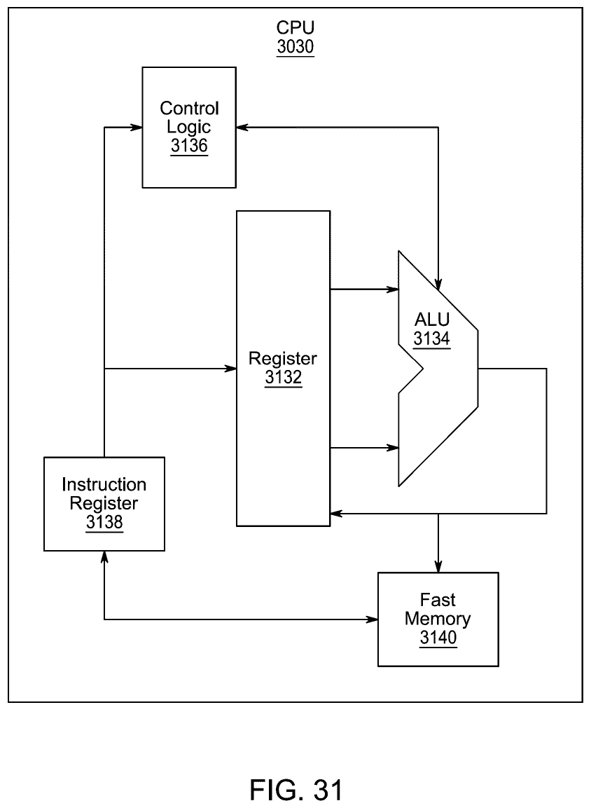

For example, FIG. 31 illustrates one implementation of CPU 3030. In one implementation, the instruction register 3138 retrieves instructions from the fast memory 3140. At least part of these instructions is fetched from the instruction register 3138 by the control logic 3136 and interpreted according to the instruction set architecture of the CPU 3030. Part of the instructions can also be directed to the register 3132. In one implementation, the instructions are decoded according to a hardwired method, and in another implementation, the instructions are decoded according to a microprogram that translates instructions into sets of CPU configuration signals that are applied sequentially over multiple clock pulses. After fetching and decoding the instructions, the instructions are executed using the arithmetic logic unit (ALU) 3134 that loads values from the register 3132 and performs logical and mathematical operations on the loaded values according to the instructions. The results from these operations can be feedback into the register and/or stored in the fast memory 3140. According to certain implementations, the instruction set architecture of the CPU 3030 can use a reduced instruction set architecture, a complex instruction set architecture, a vector processor architecture, a very large instruction word architecture. Furthermore, the CPU 3030 can be based on the Von Neuman model or the Harvard model. The CPU 3030 can be a digital signal processor, an FPGA, an ASIC, a PLA, a PLD, or a CPLD. Further, the CPU 3030 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 30, the data processing system 3000 can include that the SB/ICH 3020 is coupled through a system bus to an I/O Bus, a read only memory (ROM) 3056, universal serial bus (USB) port 3064, a flash binary input/output system (BIOS) 3068, and a graphics controller 3058. PCI/PCIe devices can also be coupled to SB/ICH 3020 through a PCI bus 3062.

The PCI devices may include, for example, Ethernet adapters, add-in cards, and PC cards for notebook computers. The Hard disk drive 3060 and CD-ROM 3056 can use, for example, an integrated drive electronics (IDE) or serial advanced technology attachment (SATA) interface. In one implementation, the I/O bus can include a super I/O (SIO) device.

Further, the hard disk drive (HDD) 3060 and optical drive 3066 can also be coupled to the SB/ICH 3020 through a system bus. In one implementation, a keyboard 3070, a mouse 3072, a parallel port 3078, and a serial port 3076 can be connected to the system bus through the I/O bus. Other peripherals and devices that can be connected to the SB/ICH 3020 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

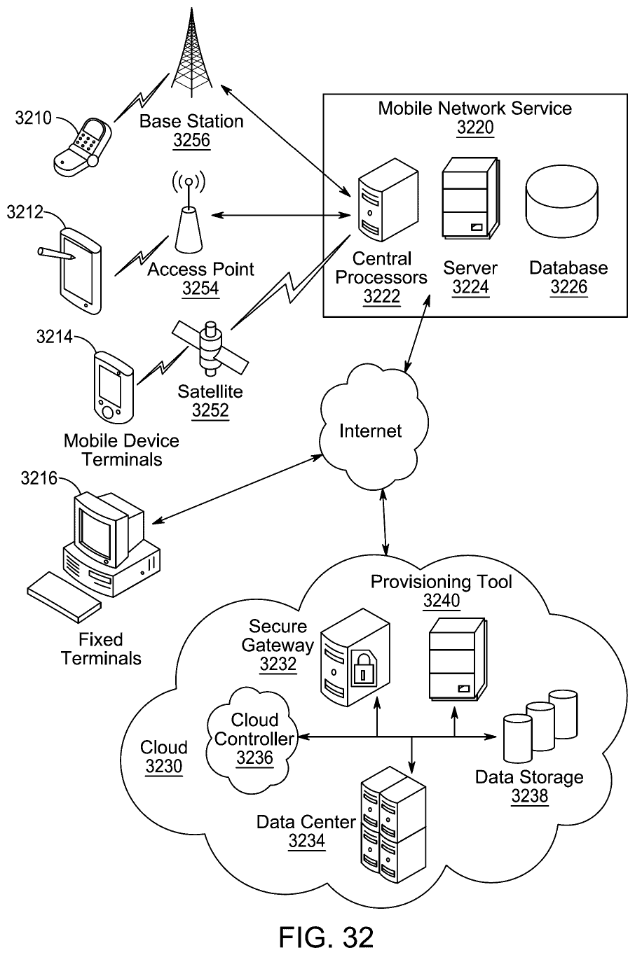

The functions and features described herein may also be executed by various distributed components of a system. For example, one or more processors may execute these system functions, wherein the processors are distributed across multiple components communicating in a network. The distributed components may include one or more client and server machines, which may share processing, as illustrated by FIG. 32, in addition to various human interface and communication devices (e.g., display monitors, smart phones, tablets, personal digital assistants (PDAs)). More specifically, FIG. 32 illustrates client devices including a smart phone 3211, a tablet 3212, a mobile device terminal 3214 and fixed terminals 3216. These client devices may be commutatively coupled with a mobile network service 3220 via a base station 3256, an access point 3254, a satellite 3252 or via an internet connection. The mobile network service 3220 may comprise central processors 3222, a server 3224 and a database 3226. The fixed terminals 3216 and the mobile network service 3220 may be commutatively coupled via an internet connection to functions in cloud 3230 that may comprise a security gateway 3232, a data center 3234, a cloud controller 3236, a data storage 3238 and a provisioning tool 3240. The network may be a private network, such as the LAN or the WAN, or may be the public network, such as the Internet. Input to the system may be received via direct user input and received remotely either in real-time or as a batch process. Additionally, some implementations may be performed on modules or hardware not identical to those described. Accordingly, other implementations are within the scope that may be disclosed.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A multisource hybrid energy storage system used in an electric vehicle, comprising:
a plurality of energy sources;
a plurality of DC-DC converters;
a DC bus;
a DC-AC inverter; and
a sliding mode controller, wherein
the plurality of energy sources include a fuel cell, a battery, a supercapacitor, and a photovoltaic panel,
the plurality of DC-DC converters include a first DC-DC converter, a second DC-DC converter, a third DC-DC converter, and a fourth DC-DC converter,
an input of the first DC-DC converter is coupled to the fuel cell, and an output of the first DC-DC converter is coupled to the DC bus,
an input of the second DC-DC converter is coupled to the battery, and an output of the second DC-DC converter is coupled to the DC bus
an input of the third DC-DC converter is coupled to the supercapacitor, and an output of the third DC-DC converter is coupled to the DC bus,
an input of the fourth DC-DC converter is coupled to the photovoltaic panel, and an output of the fourth DC-DC converter is coupled to the DC bus,
the DC-AC inverter inverts DC electric power from the DC bus into AC electric power, and supplies the AC electric power to a motor of the electric vehicle,
the sliding mode controller controls operation of the multisource hybrid energy storage system by applying a barrier-function-based controller gain to regulate a DC voltage at the DC bus to a reference voltage.

2. The multisource hybrid energy storage system of claim 1, wherein the sliding mode controller switches a controller gain between a constant value and an adaptive barrier-function-based gain.

3. The multisource hybrid energy storage system of claim 1, wherein the sliding mode controller monitors a derivative of a barrier function, and adjusts a control parameter based on the monitored derivative.

4. The multisource hybrid energy storage system of claim 1, wherein the barrier-function-based controller gain is applied based on a positive-definite barrier function (PBF) or a positive semi-definite barrier function (PSBF).

5. The multisource hybrid energy storage system of claim 1, wherein the first DC-DC converter is a DC-DC boost converter, including a resistor, an inductor, a capacitor, an insulated gate bipolar transistor (IGBT) switch, and a diode.

6. The multisource hybrid energy storage system of claim 1, wherein the second DC-DC converter is a DC-DC buck-boost converter, including a resistor, an inductor, two IGBT or Metal-Oxide-Semiconductor Field Effect Transistor (MOSFET) switches, and two diodes.

7. The multisource hybrid energy storage system of claim 1, wherein the third DC-DC converter is a DC-DC buck-boost converter, including a resistor, an inductor, two IGBT switches, and two diodes.

8. The multisource hybrid energy storage system of claim 1, wherein the fourth DC-DC converter is a DC-DC boost converter, including a resistor, an inductor, a capacitor, an IGBT switch, and a diode.

9. The multisource hybrid energy storage system of claim 1, wherein the photovoltaic panel includes a plurality of photovoltaic panels arranged in strings.

10. The multisource hybrid energy storage system of claim 1, wherein the reference voltage is 400 V.

11. An electric vehicle, comprising:
a motor; and
a multisource hybrid energy storage system for powering the motor, wherein
the multisource hybrid energy storage system includes a plurality of energy sources, a plurality of DC-DC converters, a DC bus, a DC-AC inverter, and a sliding mode controller,
the plurality of energy sources include a fuel cell, a battery, a supercapacitor, and a photovoltaic panel,
the plurality of DC-DC converters include a first DC-DC converter, a second DC-DC converter, a third DC-DC converter, and a fourth DC-DC converter,
an input of the first DC-DC converter is coupled to the fuel cell, and an output of the first DC-DC converter is coupled to the DC bus,
an input of the second DC-DC converter is coupled to the battery, and an output of the second DC-DC converter is coupled to the DC bus,
an input of the third DC-DC converter is coupled to the supercapacitor, and an output of the third DC-DC converter is coupled to the DC bus,
an input of the fourth DC-DC converter is coupled to the photovoltaic panel, and an output of the fourth DC-DC converter is coupled to the DC bus,
the DC-AC inverter inverts DC electric power from the DC bus into AC electric power, and supplies the AC electric power to the motor,
the controller is a sliding mode controller configured to apply a barrier-function-based controller gain to regulate a DC voltage at the DC bus to a reference voltage.

12. The electric vehicle of claim 11, wherein the sliding mode controller switches a controller gain between a constant value and an adaptive barrier-function-based gain.

13. The electric vehicle of claim 11, wherein the sliding mode controller monitors a derivative of a barrier function, and adjusts a control parameter based on the monitored derivative.

14. The electric vehicle of claim 11, wherein the barrier-function-based controller gain is applied based on a positive-definite barrier function (PBF) or a positive semi-definite barrier function (PSBF).

15. The electric vehicle of claim 11, wherein the first DC-DC converter is a DC-DC boost converter, including a resistor, an inductor, a capacitor, an IGBT switch, and a diode.

16. The electric vehicle of claim 11, wherein the second DC-DC converter is a DC-DC buck-boost converter, including a resistor, an inductor, two IGBT or MOSFET switches, and two diodes.

17. The electric vehicle of claim 11, wherein the third DC-DC converter is a DC-DC buck-boost converter, including a resistor, an inductor, two IGBT switches, and two diodes.

18. The electric vehicle of claim 11, wherein the fourth DC-DC converter is a DC-DC boost converter, including a resistor, an inductor, a capacitor, an IGBT switch, and a diode.

19. The electric vehicle of claim 11, wherein the photovoltaic panel includes a plurality of photovoltaic panels arranged in strings.

20. The electric vehicle of claim 11, wherein the reference voltage is 400 V.
